(19) United States
(12) Patent Application Publication
(10) Pub. No.: US 2024/0227201 A9
(43) Pub. Date: Jul. 11, 2024

(54) ROBOT, END EFFECTOR, AND ROBOT SYSTEM

(71) Applicant: SONY GROUP CORPORATION, TOKYO (JP)

(72) Inventors: KEI TSUKAMOTO, TOKYO (JP); SATOKO NAGAKARI, TOKYO (JP); YOSHIAKI SAKAKURA, TOKYO (JP); KEN KOBAYASHI, TOKYO (JP); TETSURO GOTO, TOKYO (JP)

(21) Appl. No.: 18/548,090

(22) PCT Filed: Feb. 28, 2022
(86) PCT No.: PCT/JP2022/008284

§ 371 Date: Aug. 27, 2023

(30) Foreign Application Priority Data
Mar. 4, 2021 (JP) 2021-034845

(51) Int. Cl. B25J 13/08; B25J 9/16

(52) U.S. Cl. CPC B25J 13/082; B25J 9/163; B25J 9/1633; B25J 9/1697; B25J 13/088

(57) ABSTRACT

A robot capable of performing precise work is provided.

The robot includes an actuator unit and an end effector provided at a tip of the actuator unit.

The end effector includes a first sensor capable of detecting a pressure distribution in a contact region coming into contact with a workpiece, and a second sensor capable of detecting position information of the contact region.

### TECHNICAL FIELD

The present disclosure relates to a robot, an end effector, and a robot system.

### BACKGROUND ART

In recent years, industrial robots have come to be used at production lines for various industrial products. As the industrial robots, industrial robots including an end effector (a robot hand) at a tip of a robot arm are widely known. As the end effector, an end effector having various configurations depending on content of work has been proposed.

For example, PTL 1 proposes an end effector including a palm portion, a plurality of finger portions connected to the palm portion, and a tactile sensor unit and a force acceptance portion provided for each finger portion.

### CITATION LIST

### Patent Literature

### [PTL 1]

JP 2020-49581 A

### SUMMARY

### Technical Problem

An actuator capable of performing precise position control for each finger may not be mounted on an inexpensive end effector (a robot hand) expected to become popular in the future. When such an actuator is not mounted, it becomes difficult to perform precise work (for example, work for assembling a box or the like).

An object of the present disclosure is to provide a robot, an end effector, and a robot system capable of performing precision work.

### Solution to Problem

In order to solve the above problems, the first disclosure is a robot including:
an actuator unit; and
an end effector provided at a tip of the actuator unit, and
the end effector includes:
a first sensor configured to be able to detect a pressure distribution in a contact region coming into contact with a workpiece; and
a second sensor configured to be able to detect position information of the contact region.

A second disclosure is
an end effector including:
a first sensor configured to be able to detect a pressure distribution in a contact region coming into contact with a workpiece; and
a second sensor configured to be able to detect position information of the contact region.

A third disclosure is:
a robot system including:
a robot; and
a control apparatus configured to control the robot,
wherein the robot includes:
an actuator unit; and
an end effector provided at a tip of the actuator unit, and
the end effector includes:
a first sensor configured to be able to detect a pressure distribution in a contact region coming into contact with a workpiece; and
a second sensor configured to be able to detect position information of the contact region.

### BRIEF DESCRIPTION OF DRAWINGS

FIG. 1 is a schematic diagram illustrating an example of a configuration of a robot system according to a first embodiment of the present disclosure.

FIG. 2 is a block diagram illustrating the example of the configuration of the robot system according to the first embodiment of the present disclosure.

FIG. 3 is a schematic diagram illustrating an example of a configuration of the robot hand.

FIGS. 4A and 4B are graphs illustrating examples of respective threshold values used for control of the robot hand.

FIG. 5 is a cross-sectional view illustrating an example of a configuration of a force sensor.

FIG. 6 is a plan view illustrating an example of a configuration of a detection layer.

FIG. 7 is a cross-sectional view illustrating an example of the configuration of the detection layer.

FIG. 8 is a plan view illustrating an example of a configuration of a sensing portion.

FIG. 9 is a plan view illustrating an example of an arrangement of a plurality of routing wirings.

FIG. 10 is a cross-sectional view illustrating an example of an operation of the force sensor at the time of detection of pressure.

FIG. 11 is a cross-sectional view illustrating an example of the operation of the force sensor at the time of detection of shearing force.

FIG. 12 is a graph illustrating an example of output signal distributions of a first detection layer and a second detection layer in a state in which only pressure is acting on the force sensor.

FIG. 13 is a graph illustrating an example of output signal distributions of the first detection layer and the second detection layer when shearing force is acting on the force sensor.

FIG. 14 is a cross-sectional view taken along line XIV-XIV in FIG. 6.

FIGS. 15A, 15B, and 15C are schematic diagrams illustrating an example of an operation of the robot system according to the first embodiment of the present disclosure.

FIG. 16 is a flowchart illustrating an example of the operation of the robot system according to the first embodiment of the present disclosure.

FIG. 17 is a flowchart illustrating an example of the operation of the robot system according to the first embodiment of the present disclosure.

FIG. 18 is a cross-sectional view illustrating an example of a configuration of a force sensor included in a robot hand according to a second embodiment of the present disclosure.

FIG. 19 is a cross-sectional view illustrating an example of an operation of the force sensor at the time of detection of pressure.

FIG. 20 is a cross-sectional view illustrating an example of the operation of the force sensor at the time of detection of shearing force.

FIG. 21 is a cross-sectional view illustrating an example of a configuration of a force sensor included in a robot hand according to a third embodiment of the present disclosure.

FIG. 22 is a cross-sectional view illustrating an example of an operation of the force sensor at the time of detection of pressure.

FIG. 23 is a cross-sectional view illustrating an example of the operation of the force sensor at the time of detection of shearing force.

FIG. 24 is a cross-sectional view illustrating an example of a configuration of a force sensor included in a robot hand according to a fourth embodiment of the present disclosure.

FIG. 25 is a cross-sectional view illustrating an example of an operation of the force sensor at the time of detection of pressure.

FIG. 26 is a cross-sectional view illustrating an example of the operation of the force sensor at the time of detection of shearing force.

FIG. 27 is a cross-sectional view illustrating an example of a configuration of a force sensor included in a robot hand according to a fifth embodiment of the present disclosure.

FIG. 28 is a cross-sectional view illustrating an example of a configuration of a force sensor included in a robot hand according to a sixth embodiment of the present disclosure.

FIG. 29 is a schematic diagram illustrating an example of a configuration of a dual-arm robot.

FIG. 30 is a schematic diagram illustrating an example of a configuration of a robot hand.

### DESCRIPTION OF EMBODIMENTS

Embodiments of the present disclosure will be described in the following order with reference to the drawings. Further, the same or corresponding portions are denoted by the same reference signs in all the drawings of the following embodiments.
1 First Embodiment (example of robot hand, articulated robot, and robot system)
2 Second Embodiment (example of force sensor)
3 Third Embodiment (example of force sensor)
4 Fourth Embodiment (example of force sensor)
5 Fifth Embodiment (example of force sensor)
6 Sixth Embodiment (example of force sensor)
7 Modification examples

### 1 First Embodiment

[Configuration of Robot System]

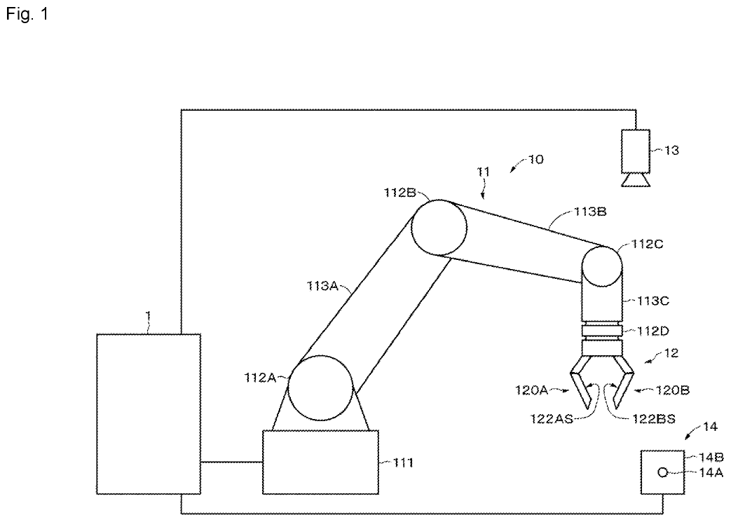

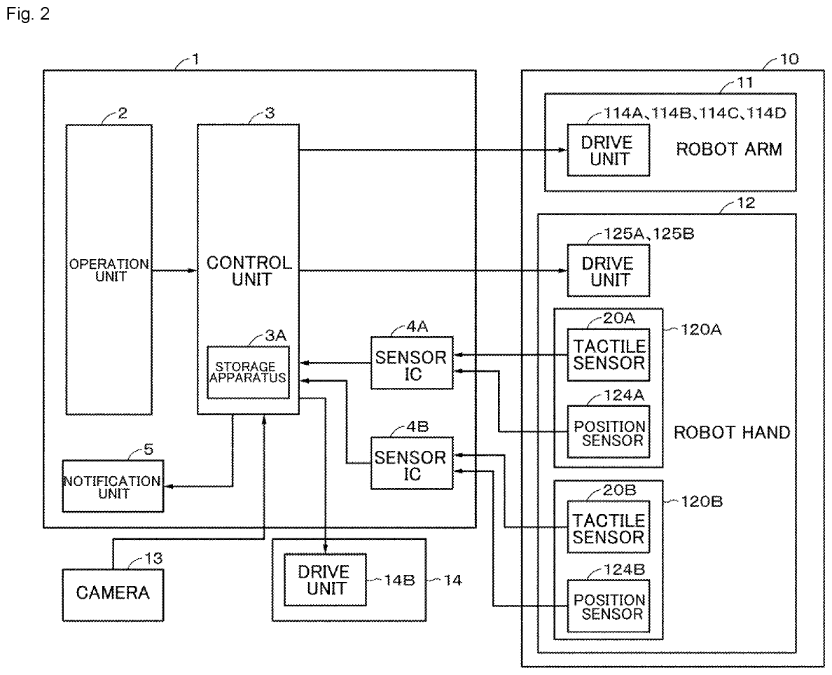

FIG. 1 is a schematic diagram illustrating an example of a configuration of a robot system according to a first embodiment of the present disclosure. FIG. 2 is a block diagram illustrating the example of the configuration of the robot system according to the first embodiment of the present disclosure. The robot system includes a robot control apparatus 1, an articulated robot 10, a camera 13, and a jig apparatus 14. The articulated robot 10 may be used for work such as assembly work, fitting work, transport work, palletizing work, or unpacking work. Specific examples of the assembly work include work for assembling a box (for example, a cardboard box), work for assembling a vehicle (for example, an automobile), and work for assembling an electronic device, but the present disclosure is not limited to this work. Work of assembling a box includes work for bending the box.

(Articulated Robot)

The articulated robot 10 is an industrial robot, and may be used for assembly work, fitting work, transport work, palletizing work, unpacking work, or the like. The articulated robot 10 is a vertically articulated robot and includes a robot arm 11 and a robot hand 12.

(Robot Arm)

The robot arm 11 is an example of an actuator unit, and is configured to be able to move a position of the end effector within a three-dimensional space. The robot arm 11 includes a base portion 111, joint portions 112A, 112B, 112C and 112D, and links 113A, 113B and 113C. The base portion 111 supports the robot arm 11 as a whole. The joint portions 112A, 112B, and 112C are configured to allow the robot arm 11 to move up and down, and left and right, and the robot arm 11 to rotate. The joint portion 112D is configured to allow the robot hand 12 to rotate.

The joint portions 112A, 112B, 112C, and 112D include drive units 114A, 114B, 114C, and 114D respectively. As the drive units 114A, 114B, 114C, and 114D, for example, an electromagnetically driven actuator, a hydraulically driven actuator, a pneumatically driven actuator, or the like is used. The joint portion 112A connects the base portion 111 to the link 113A. The joint portion 112B connects the link 113A to the link 113B. The joint portion 112C connects the link 113B to the link 113C. The joint portion 112D connects the link 113C to the robot hand 12.

(Robot Hand)

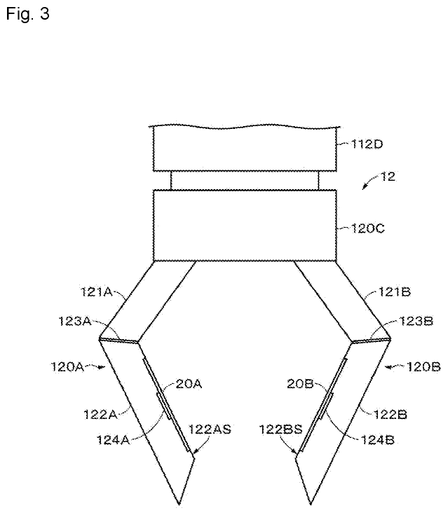

FIG. 3 is a schematic diagram illustrating an example of a configuration of the robot hand 12. The robot hand 12 is configured to be able to grip a workpiece. The robot hand 12 is provided at a tip of the robot arm 11. The robot hand 12 is an example of an end effector. The robot hand 12 includes a link 120C, a plurality of finger portions 120A and 120B, and a plurality of drive units 125A and 125B. Here, an example in which the robot hand 12 includes two finger portions 120A and 120B will be described, but the number of finger portions is not limited thereto and may be one or may be three or more.

The link 120C is connected to the joint portion 112D. The link 120C may constitute a palm portion. The finger portions 120A and 120B are connected to the link 120C. The finger portion 120A and finger portion 120B are configured to be able to grip a workpiece. The finger portion 120A has a contact region 122AS that comes into contact with a workpiece at the time of prescribed work. The finger portion 120B has a contact region 122BS that comes into contact with a workpiece at the time of prescribed work. For example, the contact regions 122AS and 122BS come into contact with the workpiece when the workpiece is gripped by the finger portions 120A and 120B. The drive unit 125A is intended to drive the finger portion 120A. The drive unit 125B is intended to drive the finger portion 120B.

The finger portion 120A includes two links 121A and 122A, a joint portion 123A, a force sensor (a first sensor) 20A, and a position sensor (a second sensor) 124A. The finger portion 120B includes two links 121B and 122B, a joint portion 123B, a force sensor (a first sensor) 20B, and a position sensor (a second sensor) 124B.

The joint portion 123A connects the link 121A to the link 122A. The finger portion 120A is configured such that a finger can be bent around the joint portion 123A. The joint portion 123B connects the link 121B to the link 122B. The finger portion 120B is configured such that the finger can be bent around the joint portion 123B. Here, an example in which the number of joint portions included in the finger portions 120A and 120B is one will be described, but the number of joint portions may be two or more.

The link 122A constitutes a fingertip of the finger portion 120A. The link 122A includes the contact region 122AS. A force sensor 20A is provided in the contact region 122AS. The position sensor 124A is provided in or near the contact region 122AS. The link 122B constitutes a fingertip of the finger portion 120B. The link 122B includes the contact region 122BS. The force sensor 20B is provided in the contact region 122BS. The position sensor 124B is provided in or near the contact region 122BS.

The force sensor 20A is configured to detect a pressure distribution and shearing force in the contact region 122AS. More specifically, the force sensor 20A detects the pressure distribution and the shearing force applied to the contact region 122AS and outputs a detection result to the sensor IC 4A under the control of the sensor IC 4A. The force sensor 20B is configured to be able to detect the pressure distribution and shearing force of the contact region 122BS. More specifically, the force sensor 20B detects the pressure distribution and the shearing force applied to the contact region 122BS and outputs a detection result to the sensor IC 4A under the control of the sensor IC 4B.

The position sensor 124A is configured to be able to detect position information of the contact region 122AS. More specifically, the position sensor 124A detects a position of the contact region 122AS (for example, a center position of the contact region 122AS) and outputs a detection result to the sensor IC 4A. The position sensor 124B is configured to be able to detect position information of the contact region 122BS. More specifically, the position sensor 124B detects the position of the contact region 122BS (for example, a center position of the contact region 122BS) and outputs a detection result to the sensor IC 4B.

Preferably, the force sensor 20A includes a substrate, and the position sensor 124A is provided on the substrate. Since this makes it possible for wirings of the force sensor 20A and the position sensor 124A to be formed on the same substrate, it is possible to simplify a connection between the force sensor 20A and the position sensor 124A, and the control IC.

It is preferable for the force sensor 20B to include a substrate, and for the position sensor 124B to be provided on the substrate. Accordingly, since it is possible to form wirings of the force sensor 20B and the position sensor 124B on the same substrate, it is possible to simplify a connection between the force sensor 20B and the position sensor 124B, and the control IC.

The substrate included in the force sensor 20A may be a flexible substrate. In this case, the force sensor 20A can be easily provided in the contact region 122AS having a curved shape. The flexible substrate may be one of components of the force sensor 20A. The substrate included in the force sensor 20B may be a flexible substrate. In this case, the force sensor 20B can be easily provided in the contact region 122BS having a curved shape. The flexible substrate may be one of components of the force sensor 20B.

(Robot Control Apparatus)

The robot control apparatus 1 is intended to control the articulated robot 10. The robot control apparatus 1 includes an operation unit 2, a control unit 3, sensor ICs 4A and 4B, and a notification unit 5.

(Operation Unit)

The operation unit 2 is intended to operate the articulated robot 10. The operation unit 2 includes a monitor, buttons, a touch panel, and the like for operating the articulated robot 10.

(Control Apparatus)

The control unit 3 controls the drive units 114A, 114B, 114C, and 114D and the drive units 125A and 125B according to an operation with respect to the operation unit 2 by a worker to cause the articulated robot 10 to perform prescribed work. The control unit 3 receives the pressure distribution and shearing force of the contact regions 122AS and 122BS from the sensor ICs 4A and 4B, and controls the articulated robot 10 on the basis of this pressure distribution and shearing force.

The control unit 3 includes a storage apparatus 3A. The storage apparatus 3A stores, for example, a first threshold value, a second threshold value, a third threshold value, and position information of the finger portions 120A and 120B. The storage apparatus 3A may further store dimensional information of a workpiece.

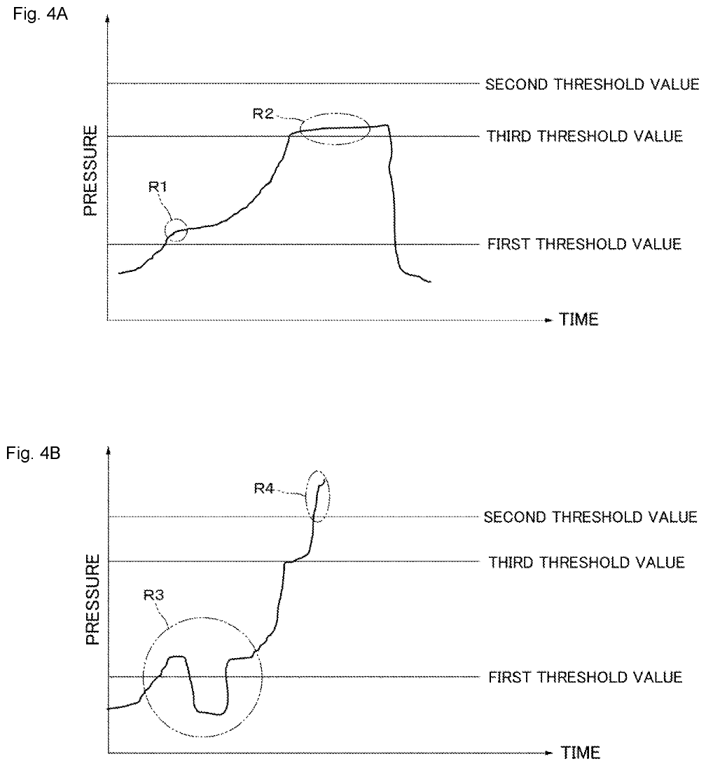

FIGS. 4A and 4B are graphs illustrating examples of settings of the first threshold value, the second threshold value, and the third threshold value. The first threshold value is a threshold value for determining whether or not the contact region 122AS of the finger portion 120A and the contact region 122BS of the finger portion 120B are in contact with the workpiece. The second threshold value is a threshold value for determining whether or not the prescribed work is progressing normally. For example, in the case of work for bending a workpiece, the second threshold value is a threshold value for determining whether or not a range of load applied to the contact regions 122AS and 122BS in normal bending work is exceeded. The third threshold value is a threshold value for determining whether or not the workpiece is bent.

As will be described below, the force sensors 20A and 20B have a plurality of detection units, and a signal value corresponding to each of the detection unit is output to the sensor ICs 4A and 4B. The output value of each detection unit is a dimensionless value (0 to 4095, for example). The sensor ICs 4A and 4B may add the output values of all the detection units as they are to calculate a sum of the output values, and output the sum to the control unit 3, and the control unit 3 may compare the sum of the output values with a threshold value. Alternatively, the sensor ICs 4A and 4B may pre-calibrate the output values of the respective detection units, convert the output values into pressure values (kPa), and output the pressure values to the control unit, and the control unit 3 may compare a maximum output value (maximum pressure) among the output values of the respective detection units with the threshold value. In the present embodiment, the latter example will be described.

The first threshold value, the second threshold value, and the third threshold value are preferably set to appropriate values according to work. For example, the first threshold value and the second threshold value are set to 1 kPa and 10 kPa, respectively. However, these numerical values are values when calibration is performed.

Position information of the finger portions 120A and 120B is three-dimensional coordinate position information of the contact regions 122AS and 122BS when the prescribed work is performed, and includes, for example, initial positions and end positions of the contact regions 122AS and 122BS in the prescribed work, and contact positions between the workpiece and the contact regions 122AS and 122BS in the prescribed work. The three-dimensional coordinate position information of the contact regions 122AS and 122BS is, for example, three-dimensional coordinate position information of centers of the contact regions 122AS and 122BS.

For example, when the prescribed work is work for bending a workpiece (for example, a material of a box), the position information of the contact regions 122AS and 122BS may be, for example, initial positions of the contact regions 122AS and 122BS, a contact position (a start position of a bending operation) between the workpiece when the contact regions 122AS and 122BS are moved from the initial positions to the workpiece and the contact regions 122AS and 122BS, and a stop position (an end position of the bending operation) of the contact regions 122AS and 122BS when the finger portions 120A and 120B are moved from the contact position and the workpiece is bent. However, one of the finger portions 120A and 120B may be moved to bend the workpiece.

The control unit 3 determines whether or not a prescribed pressure is acting on the contact regions 122AS and 122BS at prescribed positions in each operation of the work performed by the articulated robot 10, on the basis of the pressure distribution and position information received from the sensor ICs 4A and 4B When a determination is made that the prescribed pressure is acting on the contact regions 122AS and 122BS at the prescribed position, the control unit 3 causes the articulated robot 10 to perform the next operation. On the other hand, when a determination is made that the prescribed pressure is not acting on the contact regions 122AS and 122BS at the prescribed position, the control unit 3 causes the articulated robot 10 to perform the same operation again. When a determination is made that the prescribed pressure is not acting on the contact regions 122AS and 122BS at the prescribed position, the control unit 3 may stop the work performed by the articulated robot 10.

The control unit 3 determines contact between the contact regions 122AS and 122BS and the workpiece on the basis of whether or not the maximum value of the pressure distribution received from the sensor ICs 4A and 4B exceeds the first threshold value (see a region R1 in FIG. 4A). The control unit 3 determines occurrence of an abnormality in the work of the robot system, on the basis of whether or not the maximum value of the pressure distribution received from the sensor ICs 4A and 4B exceeds the second threshold value (see a region R4 in FIG. 4B). The control unit 3 determines whether or not the workpiece is bent on the basis of whether or not the maximum value of the pressure distribution received from the sensor ICs 4A and 4B exceeds the third threshold value (see a region R2 in FIG. 4A).

When an abnormality occurs in the work performed by the robot system, the control unit 3 controls the notification unit 5 to notify the worker or the like of the occurrence of the abnormality, and displays the occurrence of the abnormality on a monitor of the operation unit 2. Specifically, for example, when the control unit 3 determines that the pressure distribution received from the sensor ICs 4A and 4B exceeds the second threshold value, the control unit 3 controls the notification unit 5 to notify the worker or the like of the occurrence of the abnormality, and displays the occurrence of the abnormality on the monitor of the operation unit 2.

The control unit 3 detects a position of the workpiece on the basis of an image received from the camera 13 (an image obtained by photographing the workpiece), and controls the articulated robot 10 on the basis of a detection result.

(Sensor IC)

The sensor ICs 4A and 4B are examples of sensor control units that control the force sensors 20A and 20B. The sensor IC 4A controls the force sensor 20A to detect the pressure distribution and shearing force in the contact region 122AS and output a detection result to the control unit 3. The sensor IC 4B controls the force sensor 20B to detect the pressure distribution and shearing force in the contact region 122BS, and output detection results to the control unit 3. The sensor ICs 4A and 4B calibrate the output values of the force sensors 20A and 20B at prescribed timings such as before start of work, respectively. This makes it possible for the sensor ICs 4A and 4B to detect an accurate pressure distribution and shearing force. Although an example in which the sensor ICs 4A and 4B are included in the robot control apparatus 1 will be described in the present embodiment, the sensor ICs 4A and 4B may be included on flexible substrates of the force sensors 20A and 20B, respectively.

The sensor IC 4A controls the position sensor 124A to detect the position information of the contact region 122AS (for example, position information of a center of the contact region 122AS) and output a detection result to the control unit 3. The sensor IC 4B controls the position sensor 124B to detect the position information of the contact region 122BS (for example, position information of a center of the contact region 122BS) and output a detection result to the control unit 3. Although an example in which both the force sensor 20A and the position sensor 124A are controlled by one sensor IC 4A will be described in the first embodiment, the force sensor 20A and the position sensor 124A may be controlled by separate sensor ICs. Further, although an example in which both the force sensor 20B and the position sensor 124B are controlled by one sensor IC 4B will be described in the first embodiment, the force sensor 20B and the position sensor 124B may be controlled by separate sensor ICs.

It is preferable for the sensor IC 4A to detect the position information of the contact region 122AS in correspondence to the detection of the pressure distribution of the contact region 122AS. It is preferable for the sensor IC 4B to detect the position information of the contact region 122BS in correspondence to the detection of the pressure distribution of the contact region 122BS. The detection of the pressure distribution and the detection of the position information by the sensor IC 4A may be performed simultaneously. Similarly, the detection of the pressure distribution and the detection of the position information by the sensor IC 4B may be performed simultaneously.

(Notification Unit)

The notification unit 5 is intended to notify the worker or the like that an abnormality has occurred in the work of the robot system. As the notification unit 5, for example, an indicator lamp, an alarm device, or the like is used. These may be used alone or may be used in combination.

(Camera)

The camera 13 photographs the workpiece and outputs a captured image to the control unit 3. The camera 13 may be provided in the robot hand 12 or may be provided in a place at which a workpiece can be photographed, other than the robot hand 12.

(Jig Apparatus)

The jig apparatus 14 includes a jig 14A and a drive unit 14B. The jig 14A is intended to guide a bending position of the workpiece so that the workpiece is bent at the prescribed position. The drive unit 14B is intended to move the jig 14A.

[Configuration of Force Sensor]

Since the force sensor 20B has the same configuration as the force sensor 20A, a configuration of force sensor 20A will be described hereinafter.

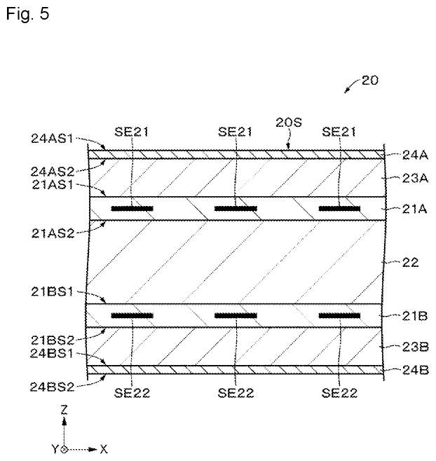

FIG. 5 is a cross-sectional view illustrating an example of the configuration of the force sensor 20A. The force sensor 20A is a capacitive sensor capable of detecting a three-axis force distribution, and detects a pressure acting on a surface of the force sensor 20A and shearing force in an in-plane direction of the force sensor 20A. The force sensor 20A has a film shape. In the present disclosure, film is defined to include a sheet. Since the force sensor 20A has the film shape, the force sensor 20A can be applied not only to a flat surface but also to a curved surface. In the present specification, axes orthogonal to each other in a plane of the surface of the force sensor 20A in a flat state are referred to as an X-axis and an Y-axis, and an axis perpendicular to the surface of the force sensor 20A in the flat state is referred to as a Z-axis.

The force sensor 20A includes a detection layer (a first detection layer) 21A, a detection layer (a second detection layer) 21B, an isolation layer 22, a deformation layer (a first deformation layer) 23A, a deformation layer (a second deformation layer) 23B, a conductive layer (a first conductive layer) 24A, and a conductive layer (a second conductive layer) 24B. An adhesive layer (not illustrated) is included between the respective layers of the force sensor 20A, and the respective layers are bonded. However, when at least one of the two adjacent layers has adhesiveness, the adhesive layer may be omitted. Between the two surfaces of the force sensor 20A, the first surface on the conductive layer 24A side is a sensing surface 20S that detects pressure and shearing force, and a second surface opposite to the sensing surface 20S is a back surface bonded to the contact region 122AS of the finger portion 120A. The detection layers 21A and 21B are connected to the sensor IC 4A via wirings. An exterior material such as an exterior film may be provided on the conductive layer 24A.

The detection layer 21A includes a first surface 21AS1 and a second surface 21AS2 opposite to the first surface 21AS1. The detection layer 21B includes a first surface 21BS1 facing the first surface 21AS1, and a second surface 21BS2 opposite to the first surface 21BS1. The detection layer 21A and the detection layer 21B are disposed in parallel. The isolation layer 22 is provided between the detection layer 21A and the detection layer 21B. The conductive layer 24A is provided to face the first surface 21AS1 of the detection layer 21A. The conductive layer 24A is disposed in parallel to the detection layer 21A. The conductive layer 24B is provided to face the second surface 21BS2 of the detection layer 21B. The conductive layer 24B is disposed in parallel to the detection layer 21B. The deformation layer 23A is provided between the detection layer 21A and the conductive layer 24A. The deformation layer 23B is provided between the detection layer 21B and the conductive layer 24B.

(Detection Layer) The detection layer 21A and the detection layer 21B are capacitive detection layers and, more specifically, mutually capacitive detection layers. The detection layer 21A has flexibility. The detection layer 21A is bent toward the detection layer 21B when pressure acts on the sensing surface 20S. The detection layer 21A includes a plurality of sensing portions (first sensing portions) SE21. The sensing portion SE21 detects the pressure acting on the sensing surface 20S and outputs a detection result to the sensor IC 4A. Specifically, the sensing portion SE21 detects capacitance corresponding to a distance between the sensing portion SE21 and the conductive layer 24A, and outputs a detection result to the sensor IC 4A.

The detection layer 21B has flexibility. The detection layer 21B is bent toward the conductive layer 24B when pressure acts on the sensing surface 20S. The detection layer 21B includes a plurality of sensing portions (second sensing portions) SE22. The sensing portion SE22 detects the pressure acting on the sensing surface 20S and outputs a detection result to the sensor IC 4A.

Specifically, the sensing portion SE22 detects capacitance corresponding to a distance between the sensing portion SE22 and the conductive layer 24B, and outputs a detection result to the sensor IC 4A.

A disposition pitch P1 of the plurality of sensing portions SE21 included in the detection layer 21A is the same as a disposition pitch P2 of the plurality of sensing portions SE22 included in the detection layer 21B. In an initial state in which no shearing force is applied, the sensing portion SE22 is provided at a position facing the sensing portion SE21. That is, in the initial state in which no shearing force is applied, the sensing portions SE22 and the sensing portions SE22 overlap in a thickness direction of the force sensor 20A. However, it is also possible to adopt a configuration in which the sensing portion SE22 is not provided at the position facing the sensing portion SE21 in the initial state in which no shearing force is applied.

Since the detection layer 21B has the same configuration as the detection layer 21A, only the configuration of the detection layer 21A will be described hereinafter.

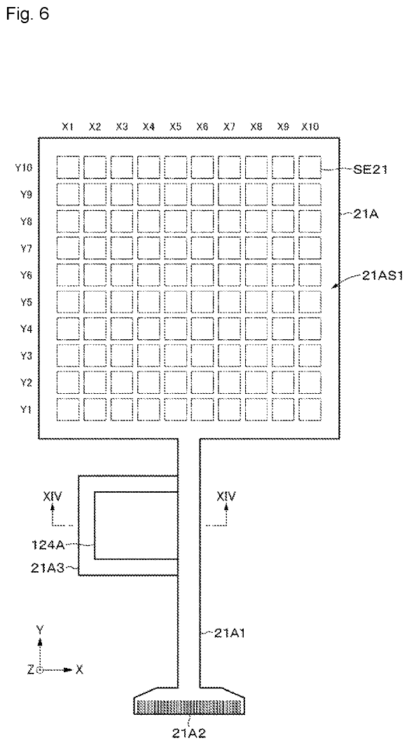

FIG. 6 is a plan view illustrating an example of the configuration of the detection layer 21A. The plurality of sensing portions SE21 are arranged in a matrix form. The sensing portion SE21 has, for example, a square shape. However, a shape of the sensing portion SE21 is not particularly limited, and may be a circular shape, an elliptical shape, a polygonal shape other than a square shape, or the like.

In FIG. 6, symbols X1 to X10 denote center positions of the sensing portions SE21 in an X-axis direction, and symbols Y1 to Y10 denote center positions of the sensing portions SE21 in a Y-axis direction.

A film-like connection portion 21A1 extends from a portion of the periphery of the detection layer 21A. A plurality of connection terminals 21A2 for connection to other substrates are provided at a tip of the connection portion 21A1.

It is preferable for the detection layer 21A and the connection portion 21A1 to be integrally configured by one flexible printed circuit (FPC). The detection layer 21A and the connection portion 21A1 are integrally configured in this manner, making it possible to reduce the number of parts of the force sensor 20A.

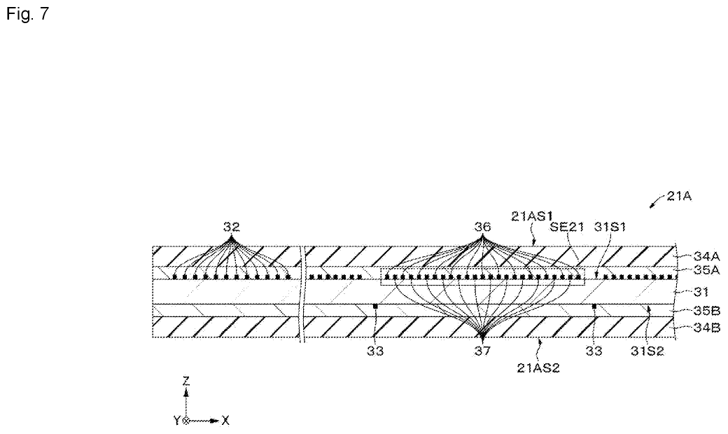

FIG. 7 is a cross-sectional view illustrating an example of the configuration of the detection layer 21A. The detection layer 21A includes a base material 31, the plurality of sensing portions SE21, a plurality of routing wirings 32, a plurality of routing wirings 33, a coverlay film 34A, a coverlay film 34B, an adhesive layer 35A, and an adhesive layer 35B.

The base material 31 includes a first surface 31S1, and a second surface 31S2 opposite to the first surface 31S1. The plurality of sensing portions SE21 and the plurality of routing wirings 32 are provided on the first surface 31S1 of the base material 31. The plurality of routing wirings 33 are provided on the second surface 31S2 of the base material. The coverlay film 34A is bonded to the first surface 31S1 of the base material 31 on which the plurality of sensing portions SE21 and the plurality of routing wirings 32 are provided, by the adhesive layer 35A. The coverlay film 34B is bonded to the second surface 31S2 of the base material 31 on which the plurality of routing wirings 33 are provided, by the adhesive layer 35B.

The base material 31 has flexibility. The base material 31 has a film shape. The base material 31A contains a polymer resin. Examples of the polymer resin may include polyethylene terephthalate (PET), polyethylene naphthalate (PEN), polycarbonate (PC), acrylic resin (PMMA), polyimide (PI), triacetylcellulose (TAC), polyester, polyamide (PA), aramid, polyethylene (PE), polyacrylate, polyethersulfone, polysulfone, polypropylene (PP), diacetyl cellulose, polyvinyl chloride, epoxy resin, urea resin, urethane resin, melamine resin, cyclic olefin polymer (COP), and norbornene thermoplastic resin, but the present disclosure is not limited to these polymer resins.

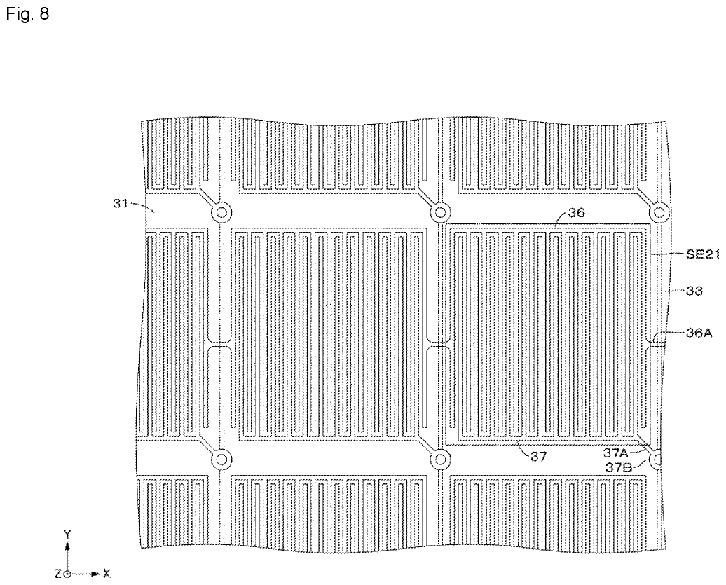

FIG. 8 is a plan view illustrating an example of a configuration of the sensing portion SE21. The sensing portion SE21 is configured of a sense electrode (a reception electrode (a first electrode)) 36 and a pulse electrode (a transmission electrode (a second electrode)) 37. The sense electrode 36 and the pulse electrode 37 are configured to be able to form capacitive coupling. More specifically, the sense electrode 36 and the pulse electrode 37 have a comb-like shape and are arranged so that the comb-like portions are engaged with each other.

The sense electrodes 36 adjacent to each other in the X-axis direction are connected by a connection line 36A. A lead wiring 37A is provided in each pulse electrode 37, and a tip of the lead wiring 37A is connected to the routing wiring 33 via a through hole 37B. The routing wiring 33 connects the pulse electrodes 37 adjacent to each other in the Y-axis direction.

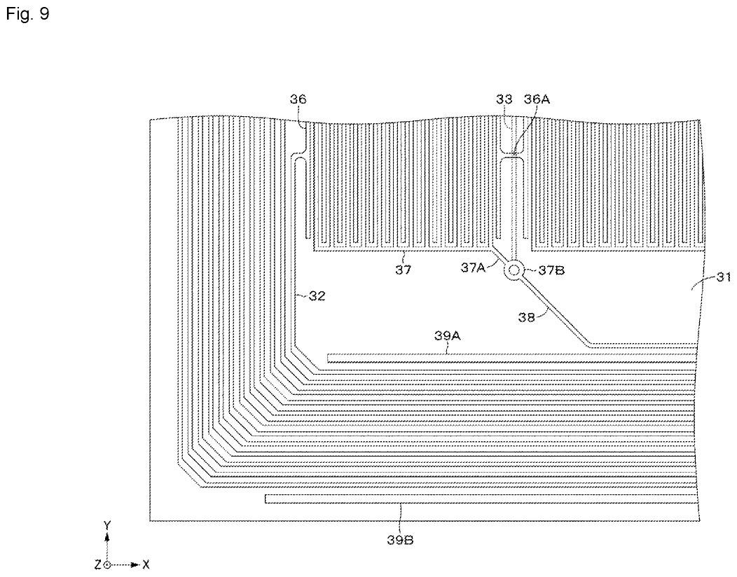

FIG. 9 is a plan view illustrating an example of arrangement of the plurality of routing wirings 32 and the plurality of routing wirings 33. Among the plurality of sense electrodes 36 connected by a plurality of connection lines 36A, the routing wiring 32 is led out from the sense electrode 36 located at one end in the X-axis direction. The plurality of routing wirings 32 are routed to a peripheral portion of the first surface 31S1 of the base material 31, and are connected to the connection terminals 21A2 through the connection portions 21A1.

The detection layer 21A further includes a plurality of routing wirings 38. The routing wiring 38 is connected to a lead wiring 37A lead out from the pulse electrode 37 located at one end in the Y-axis direction among the plurality of pulse electrodes 37 connected by the routing wiring 33. The plurality of routing wirings 38 are routed to the peripheral portion of the first surface 31S1 of the base material 31 together with the plurality of routing wirings 32, and are connected to the connection terminals 21A2 through the connection portion 21A1.

The detection layer 21A further includes a ground electrode 39A and a ground electrode 39B. The ground electrode 39A and the ground electrode 39B are connected to a reference potential. The ground electrode 39A and the ground electrode 39B extend in parallel with the plurality of routing wirings 32. The plurality of routing wirings 32 are provided between the ground electrode 39A and the ground electrode 39B. The plurality of routing wirings 32 are provided between the ground electrode 39A and the ground electrode 39B in this way, making it possible to suppress external noise (external electric field) entering the plurality of routing wirings 32. Therefore, it is possible to suppress a decrease in detection accuracy or erroneous detection of the force sensor 20A due to the external noise.

(Isolation Layer)

The isolation layer 22 isolates the detection layer 21A from the detection layer 21B. This makes it possible to suppress electromagnetic interference between the detection layer 21A and the detection layer 21B. The isolation layer 22 is configured to be elastically deformable in an in-plane direction of the sensing surface 20S due to the shearing force acting in the in-plane direction of the sensing surface 20S (that is, the in-plane direction of the force sensor 20A).

The isolation layer 22 preferably contains a gel. The isolation layer 22 contains the gel, making it difficult for the isolation layer 22 to be crushed by pressure acting on the sensing surface 20S, and easy for the isolation layer 22 to be elastically deformed by the shearing force acting in the in-plane direction of the sensing surface 20S, thereby obtaining a desirable property for the isolation layer 22. The gel is, for example, at least one polymer gel selected from a group consisting of silicone gel, urethane gel, acrylic gel, and styrene gel. The isolation layer 22 may be supported by a base material (not illustrated).

A 25% CLD (Compression-Load-Deflection) value of the isolation layer 22 is ten times or more the 25% CLD value of the deformation layer 23A, preferably, 30 times or more the 25% CLD value of the deformation layer 23A, and more preferably, 50 times or more the 25% CLD value of the deformation layer 23A. When a 25% CLD value of the isolation layer 22 is ten times or more the 25% CLD value of the deformation layer 23A, and pressure acts on the sensing surface 20S, it becomes easy for the deformation layer 23A to be sufficiently crushed as compared with the isolation layer 22, making it possible to improve the detection sensitivity of the sensing portion SE21.

The 25% CLD value of the isolation layer 22 is ten times or more the 25% CLD value of the deformation layer 23B, preferably, 30 times or more the 25% CLD value of the deformation layer 23B and, more preferably, 50 times or more the 25% CLD value of the deformation layer 23B. When the 25% CLD value of the isolation layer 22 is ten times or more the 25% CLD value of the deformation layer 23B, and pressure acts on the sensing surface 20S, it becomes easy for the deformation layer 23B to be sufficiently crushed as compared with the isolation layer 22, making it possible to improve the detection sensitivity of the sensing portion SE22.

The 25% CLD value of the isolation layer 22 is preferably 500 kPa or less. When the 25% CLD value of the isolation layer 22 exceeds 500 kPa, there is concern that elastic deformation in the in-plane direction of the sensing surface 20S becomes difficult due to the shearing force acting in the in-plane direction of the sensing surface 20S (that is, the in-plane direction of the force sensor 20A). Therefore, there is concern that the detection sensitivity of the force sensor 20A for the shearing force in the in-plane direction is degraded.

The 25% CLD values of the isolation layer 22, the deformation layer 23A, and the deformation layer 23B are measured according to JIS K 6254.

A thickness of the isolation layer 22 is preferably twice or more the thickness of the deformation layer 23A, more preferably, four times or more the thickness of the deformation layer 23A, and even more preferably, eight times or more the thickness of the deformation layer 23A. When the thickness of the isolation layer 22 is twice or more the thickness of the deformation layer 23A, and shearing force acts in the in-plane direction of the sensing surface 20S, it becomes easy for the isolation layer 22 to be sufficiently deformed in the in-plane direction of the sensing surface 20S as compared with the deformation layer 23A, making it possible to further improve the shearing force detection sensitivity.

The thickness of the isolation layer 22 is preferably twice or more the thickness of the deformation layer 23B, more preferably, four times or more the thickness of the deformation layer 23B, and even more preferably, eight times or more the thickness of the deformation layer 23B. When the thickness of the isolation layer 22 is twice or more the thickness of the deformation layer 23B and shearing force acts in the in-plane direction of the sensing surface 20S, it becomes easy for the isolation layer 22 to be sufficiently deformed in the in-plane direction of the sensing surface 20S as compared with the deformation layer 23B, making it possible to further improve the shearing force detection sensitivity.

The thickness of the isolation layer 22 is preferably 10000 μm or less and, more preferably, 4000 μm or less. When the thickness of the isolation layer 22 exceeds 10000 μm, there is concern that it becomes difficult to apply the force sensor 20A to an electronic device or the like.

Thicknesses of the isolation layer 22, the deformation layer 23A, and the deformation layer 23B are obtained as follows. First, the force sensor 20A is processed by using a Focused Ion Beam (FIB) method or the like so that a cross section is produced, and a cross section image is captured using a scanning electron microscope (SEM). Next, using this cross-sectional image, the thicknesses of the isolation layer 22, the deformation layer 23A, and the deformation layer 23B are measured.

A basis weight of the isolation layer 22 is preferably ten times or more the basis weight of the deformation layer 23A, and more preferably, 25 times or more the basis weight of the deformation layer 23A. When the basis weight of the isolation layer 22 is ten times or more the basis weight of the deformation layer 23A, and pressure acts on the sensing surface 20S, it becomes easy for the deformation layer 23A to be sufficiently crushed as compared with the isolation layer 22, making it possible to further improve the detection sensitivity of the sensing portion SE21.

The basis weight of the isolation layer 22 is preferably ten times or more the basis weight of the deformation layer 23B, and more preferably, 25 times or more the basis weight of the deformation layer 23B. When the basis weight of the isolation layer 22 is ten times or more the basis weight of the deformation layer 23B, and pressure acts on the sensing surface 20S, it becomes easy for the deformation layer 23B to be sufficiently crushed as compared with the isolation layer 22, making it possible to further improve the detection sensitivity of the sensing portion SE22.

The basis weight of the isolation layer 22 is preferably 1000 mg/cm² or less. When the basis weight of the isolation layer 22 exceeds 1000 mg/cm², there is concern that elastic deformation in the in-plane direction of the sensing surface 20S becomes difficult due to the shearing force acting in the in-plane direction of the sensing surface 20S (that is, the in-plane direction of the force sensor 20A). Therefore, there is concern that the detection sensitivity of the force sensor 20A for the shearing force in the in-plane direction is degraded.

The basis weight of the isolation layer 22 is obtained as follows. First, the conductive layer 24A, the deformation layer 23A, and the detection layer 21A are peeled off from the force sensor 20A so that a surface of the isolation layer 22 is exposed, and then, in this state, a mass M1 of the force sensor 20A is measured. Next, the isolation layer 22 is removed by being dissolved with a solvent, for example, and then, in this state, a mass M2 of the force sensor 20A is measured. Finally, the basis weight of the deformation layer 23 is obtained from the following equation. The basis weight [mg/cm²] of the isolation layer 22=(mass M1−mass M2)/(area Si of the isolation layer 22)

The basis weight of the deformation layer 23A is obtained as follows. First, the conductive layer 24A is peeled off from the force sensor 20A so that a surface of the deformation layer 23A is exposed, and then, in this state, a mass M3 of the force sensor 20A is measured. Next, the deformation layer 23A is removed by being dissolved with a solvent, for example, and then, in this state, a mass M4 of the force sensor 20A is measured. Finally, the basis weight of the deformation layer 23A is obtained from the following equation.

The basis weight [mg/cm²] of the deformation layer 23A=(mass M3−mass M4)/(area S2 of the deformation layer 23A)

The basis weight of the deformation layer 23B is obtained as follows. First, the conductive layer 24B is peeled off from the force sensor 20A so that a surface of the deformation layer 23B is exposed, and then, in this state, a mass M5 of the force sensor 20A is measured. Next, the deformation layer 23B is removed by being dissolved with a solvent, for example, and then, in this state, a mass M6 of the force sensor 20A is measured. Finally, the basis weight of the deformation layer 23B is obtained from the following equation.

The basis weight [mg/cm²] of the deformation layer 23B=(mass M5−mass M6)/(area S3 of the deformation layer 23B)

(Conductive Layer)

The conductive layer 24A has at least one of flexibility and stretchability. The conductive layer 24A is bent toward the detection layer 21A when pressure acts on the sensing surface 20S. The conductive layer 24B may or may not have at least one of flexibility and stretchability, but it is preferable to have the flexibility so that the force sensor 20A can be mounted on a curved surface.

The conductive layer 24A includes a first surface 24AS1 and a second surface 24AS2 opposite to the first surface 24AS1. The second surface 24AS2 faces the first surface 21AS1 of the detection layer 21A. The conductive layer 24B includes a first surface 24BS1 and a second surface 24BS2 opposite to the first surface 24BS1. The first surface 24BS1 faces the second surface 21BS2 of the detection layer 21B.

An elastic modulus of the conductive layer 24A is preferably 10 MPa or less. When the elastic modulus of the conductive layer 24A is 10 MPa or less, the flexibility of the conductive layer 24A is improved, and when pressure acts on the sensing surface 20S, the pressure is easily transmitted to the detection layer 21B, and the detection layer 21B is easily deformed. Therefore, it is possible to improve the detection sensitivity of the sensing portion SE22. The elastic modulus is measured according to JIS K 7161.

The conductive layer 24A and the conductive layer 24B are so-called ground electrodes and are connected to the reference potential. Examples of the shape of the conductive layer 24A and the conductive layer 24B include a thin film shape, a foil shape, and a mesh shape like, but the shape is not limited to these shapes. Each of the conductive layers 24A and 24B may be supported by a base material (not illustrated).

The conductive layers 24A and 24B may have electrical conductivity, and is, for example, an inorganic conductive layer containing an inorganic conductive material, an organic conductive layer containing an organic conductive material, or an organic-inorganic conductive layer containing both an inorganic conductive material and an organic conductive material. The inorganic conductive material and the organic conductive material may be particles. The conductive layers 24A, 24B may be conductive clothes.

Examples of the inorganic conductive material include a metal and a metal oxide. Here, the metal is defined to include a semimetal. Examples of the metal may include a metal such as aluminum, copper, silver, gold, platinum, palladium, nickel, tin, cobalt, rhodium, iridium, iron, ruthenium, osmium, manganese, molybdenum, tungsten, niobium, tantalum, titanium, bismuth, antimony, or lead, and an alloy containing two or more of these metals, but the present disclosure is not limited to these metals. Specific examples of the alloy may include stainless steel, but the present disclosure is not limited thereto. Examples of the metal oxide may include indium tin oxide (ITO), zinc oxide, indium oxide, antimony-added tin oxide, fluorine-added tin oxide, aluminum-added zinc oxide, gallium-added zinc oxide, silicon-added zinc oxide, zinc oxide-tin oxide, indium oxide-tin oxide, and zinc oxide-indium oxide-magnesium oxide, but the present disclosure is not limited to these metal oxides.

Examples of the organic conductive material include a carbon material and a conductive polymer. Examples of the carbon material may include carbon black, carbon fiber, fullerene, graphene, carbon nanotube, carbon microcoil, and nanohorn, but the present disclosure is not limited to these carbon materials. As the conductive polymer, for example, substituted or unsubstituted polyaniline, polypyrrole, polythiophene, or the like can be used, but the present disclosure is not limited to these conductive polymers.

The conductive layers 24A and 24B may be thin films produced by either a dry process or a wet process. As the dry process, for example, a sputtering method or a vapor deposition method can be used, but the present disclosure is not particularly limited thereto.

The conductive layers 24A and 24B are provided on both surfaces of the force sensor 20A, making it possible to suppress external noise (external electric field) entering the force sensor 20A from both main surfaces of the force sensor 20A. Therefore, it is possible to suppress a decrease in the detection accuracy or erroneous detection of the force sensor 20A due to external noise.

(Deformation Layer)

The deformation layer 23A isolates the detection layer 21A from the conductive layer 24A so that the detection layer 21A and the conductive layer 24A are parallel. It is possible to adjust the sensitivity and dynamic range of the sensing portion SE21 depending on the thickness of the deformation layer 23A. The deformation layer 23A is configured to be elastically deformable depending on the pressure acting on the sensing surface 20S, that is, the pressure acting in the thickness direction of the force sensor 20A. The deformation layer 23A may be supported by a base material (not illustrated).

The deformation layer 23B isolates the detection layer 21B from the conductive layer 24B so that the detection layer 21B and the conductive layer 24B are parallel. It is possible to adjust the sensitivity and dynamic range of the sensing portion SE22 depending on the thickness of the deformation layer 23B. The deformation layer 23B is configured to be elastically deformable depending on the pressure acting on the sensing surface 20S, that is, the pressure acting in the thickness direction of the force sensor 20A. The deformation layer 23A may be supported by a base material (not illustrated).

25% CLD values of the deformation layer 23A and the deformation layer 23B may be the same or substantially the same. The deformation layers 23A and 23B contain, for example, foamed resin or insulating elastomer. The foamed resin is a so-called sponge, and is, for example, at least one of foamed polyurethane (polyurethane foam), foamed polyethylene (polyethylene foam), foamed polyolefin (polyolefin foam), foamed acrylic (acrylic foam), sponge rubber, and the like. The insulating elastomer is, for example, at least one of silicone elastomer, acrylic elastomer, urethane elastomer, styrene elastomer, and the like.

(Adhesive Layer)

The adhesive layer is configured of an insulating adhesive or a double-sided adhesive film. As the adhesive, for example, at least one of an acrylic adhesive, a silicone adhesive, and a urethane adhesive can be used. In the present disclosure, pressure sensitive adhesion is defined as a type of adhesion. According to this definition, a pressure sensitive adhesion layer is considered a type of adhesive layer.

[Operation of Force Sensor]

(Operation of Force Sensor at time of Pressure Detection)

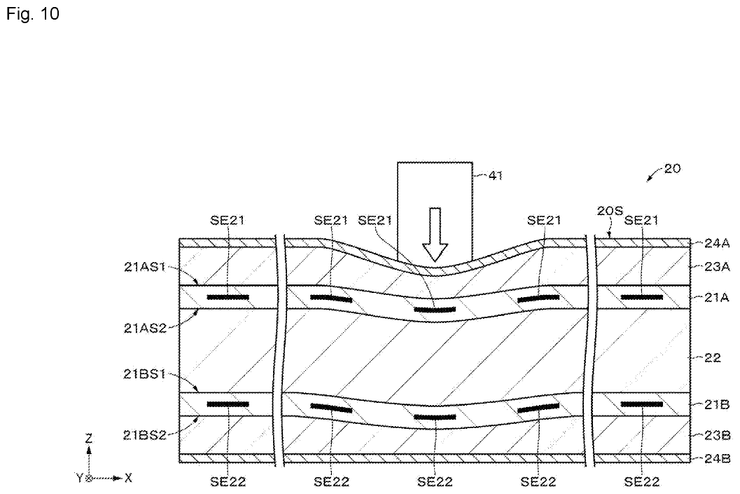

FIG. 10 is a cross-sectional view illustrating an example of an operation of the force sensor 20A at the time of detection of pressure. When the sensing surface 20S is pressed by an object 41 and pressure acts on the sensing surface 20S, the conductive layer 24A is bent toward the detection layer 21A around a location on which the pressure acts, to crush a portion of the deformation layer 23A. Accordingly, the conductive layer 24A and the detection layer 21A partially approach each other. As a result, some of electric force lines of the plurality of sensing portions SE21 included in a portion of the detection layer 21A that has approached the conductive layer 24A (that is, some of the electric force lines between the sense electrode 36 and the pulse electrode 37) flow into the conductive layer 24A, and a capacitance of the plurality of sensing portions SE21 changes.

Further, the pressure acts on the first surface 21AS1 of the detection layer 21A due to the portion of the deformation layer 23A crushed as described above, and the detection layer 21A, the isolation layer 22, and the detection layer 21B are bent toward the conductive layer 24B around the location on which the pressure acts. Accordingly, the detection layer 21B and the conductive layer 24B partially approach each other. As a result, some of electric force lines of the plurality of sensing portions SE22 included in a portion of the detection layer 21B that has approached the conductive layer 24B (that is, some of the electric force lines between the sense electrode 36 and the pulse electrode 37) flow into the conductive layer 24B, and a capacitance of the plurality of sensing portions SE22 changes.

The sensor IC 4A sequentially scans the plurality of sensing portions SE21 included in the detection layer 21A to acquire the output signal distribution, that is, the capacitance distribution, from the plurality of sensing portions SE21. Similarly, the sensor IC 4A sequentially scans the plurality of sensing portions SE22 included in the detection layer 21B to acquire the output signal distribution, that is, the capacitance distribution, from the plurality of sensing portions SE21. The sensor IC 4A outputs the acquired output signal distribution to the control unit 3.

The control unit 3 calculates a magnitude of the pressure and a position on which the pressure acts on the basis of the output signal distribution received from the detection layer 21A via the sensor IC 4A. The reason why the magnitude of the pressure and the position on which the pressure acts are calculated on the basis of the output signal distribution from the detection layer 21A is that the detection layer 21A is closer to the sensing surface 20S than the detection layer 21B and has high detection sensitivity. However, the control unit 3 may calculate the magnitude of the pressure and the position on which the pressure acts on the basis of the output signal distribution received from the detection layer 21B via the sensor IC 4A, and may calculate the magnitude of the pressure and the position on which the pressure acts on the basis of the output signal distributions received from the detection layer 21A and the detection layer 21B via the sensor IC 4A.

(Operation of Force Sensor at Time of shearing force Detection)

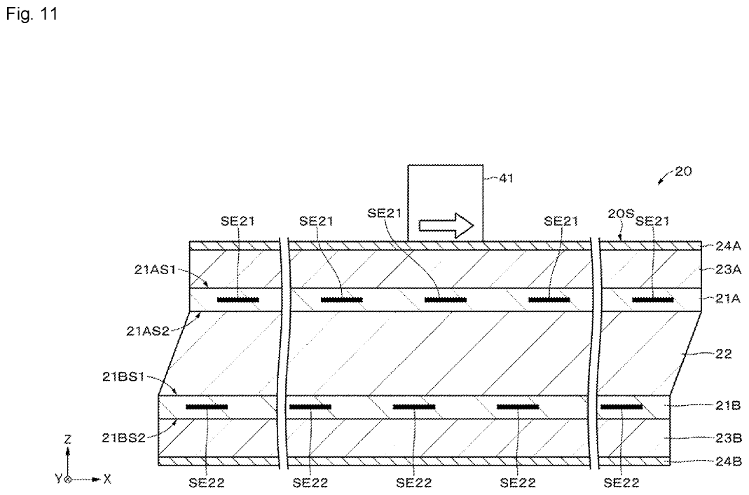

FIG. 11 is a cross-sectional view illustrating an example of an operation of the force sensor 20A at the time of detection of shearing force. When the object 41 moves in the in-plane direction of the sensing surface 20S and shearing force acts on the force sensor 20A, the isolation layer 22 is elastically deformed in the in-plane direction of the force sensor 20A, and relative positions of the detection layer 21A and the detection layer 21B in the in-plane direction (X and Y directions) of the force sensor 20A are shifted. That is, relative positions of the sensing portions SE21 and SE22 in the in-plane direction of the force sensor 20A are shifted. Accordingly, the centroid position of the output signal distribution (a capacitance distribution) of the detection layer 21A and the centroid position of the output signal distribution (a capacitance distribution) of the detection layer 21B are shifted in the in-plane direction (X and Y directions) of the force sensor 20A. In order to detect the shearing force, it is necessary for pressure to be applied to the sensing surface 20S by the object 41, but the deformation of each layer of the force sensor 20A due to this pressure is omitted in FIG. 11.

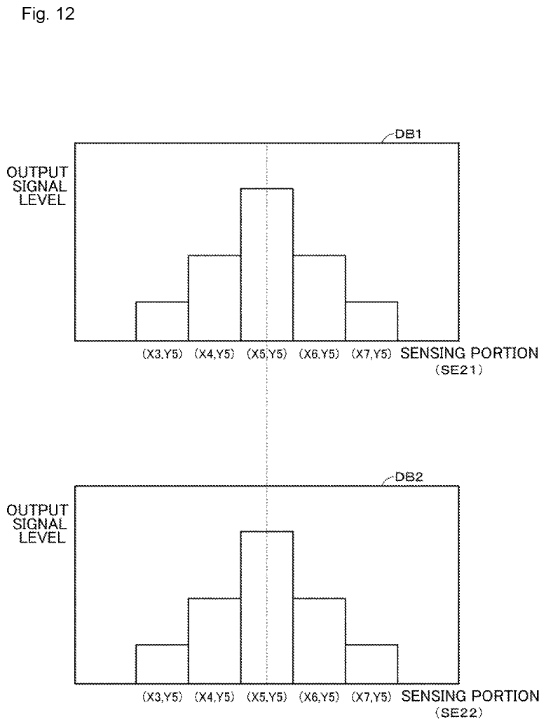

FIG. 12 is a graph illustrating an example of an output signal distribution DB1 of the detection layer 21A and an output signal distribution DB2 of the detection layer 21B in a state in which only pressure is acting on the force sensor 20A. The output signal distribution DB1 and the output signal distribution DB2 correspond to the capacitance distribution (pressure distribution). In a state in which only pressure is acting on the force sensor 20A, centroid positions of the output signal distribution DB1 of the detection layer 21A and the output signal distribution DB2 of the detection layer 21B match.

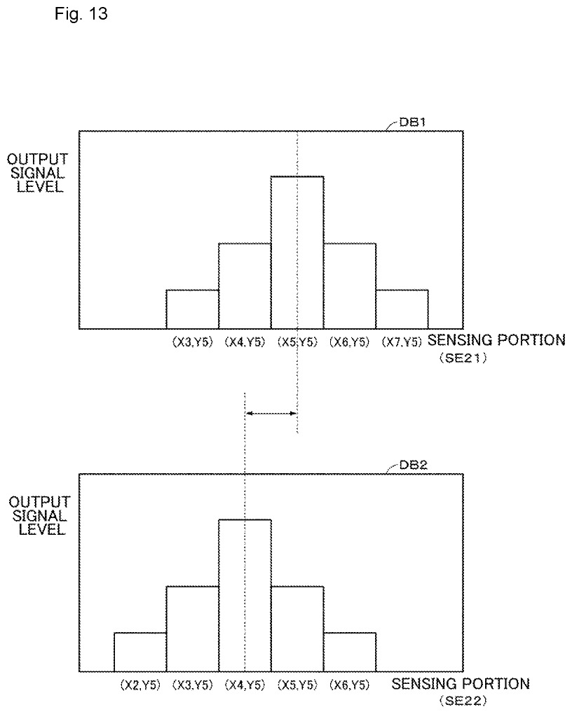

FIG. 13 is a graph illustrating an example of the output signal distribution DB1 of the detection layer 21A and the output signal distribution DB2 of the detection layer 21B in a state in which shearing force is acting on the force sensor 20A. In the state in which the shearing force acts on the force sensor 20A, the centroid positions of the output signal distribution DB1 of the detection layer 21A and the output signal distribution DB2 of the detection layer 21B are shifted.

The control unit 3 calculates triaxial force on the basis of the output signal distribution of the detection layer 21A and the output signal distribution of the detection layer 21B output from the sensor IC 4A. More specifically, the control unit 3 calculates the centroid position of the pressure in the detection layer 21A from the output signal distribution DB1 of the detection layer 21A, and calculates the centroid position of the pressure in the detection layer 21B from the output signal distribution DB2 of the detection layer 21B. The control unit 3 calculates a magnitude and direction of the shearing force from a difference between the centroid position of the pressure in the detection layer 21A and the centroid position of the pressure in the detection layer 21B.

The control unit 3 calculates an amount of position shift of the workpiece gripped by the end effector on the basis of the output signal distribution of the detection layer 21A and the output signal distribution of the detection layer 21B output from the sensor IC 4A. More specifically, the control unit 3 calculates an amount of position shift of the workpiece gripped by the end effector from the difference between the centroid position of the pressure in the detection layer 21A and the centroid position of the pressure in the detection layer 21B.

[Configuration of Position Sensor]

Since the position sensor 124B has the same configuration as the position sensor 124A, the configuration of the position sensor 124A will be described hereinafter.

The position sensor 124A is configured to be able to detect the position of the contact region 122AS in the space. The position sensor 124A is preferably provided at a location other than a detection portion of the force sensor 20A.

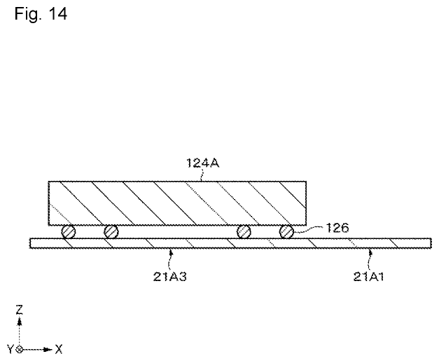

FIG. 14 is a cross-sectional view taken along line XIV-XIV in FIG. 6. As illustrated in FIGS. 6 and 14, the flexible printed circuit board includes a detection layer 21A, a connection portion 21A1, a protrusion portion 21A3, and a position sensor 124A.

The protrusion portion 21A3 is a support for supporting the position sensor 124A. The protrusion portion 21A3 protrudes from the connection portion 21A1. The protrusion portion 21A3 has a film shape like the connection portion 21A1. An electrode (not illustrated) for mounting the position sensor 124A is provided on one main surface of the protrusion portion 21A3.

The position sensor 124A detects the position of the contact region 122AS and outputs an acquisition result to the control unit 3 via the sensor IC 4A. Accordingly, the control unit 3 can receive position information of the force sensor 20A together with the pressure distribution from the force sensor 20A. Therefore, the control unit 3 can detect the position of the contact region 122AS in the three-dimensional space, and the pressure distribution and shearing force applied to the contact region 122AS at the position on the basis of the pressure distribution and position information received from the force sensor 20A and the position sensor 124A via the sensor IC 4A.

The position sensor 124A is provided on one main surface of the protrusion portion 21A3. The position sensor 124A is mounted on an electrode provided on the one main surface of the protrusion portion 21A3 via solder 126, for example. FIG. 14 illustrates an example in which the solder 126 is a solder ball. The electrodes and the plurality of connection terminals 21A2 are connected by wirings (not illustrated).

[Operation of Robot System]

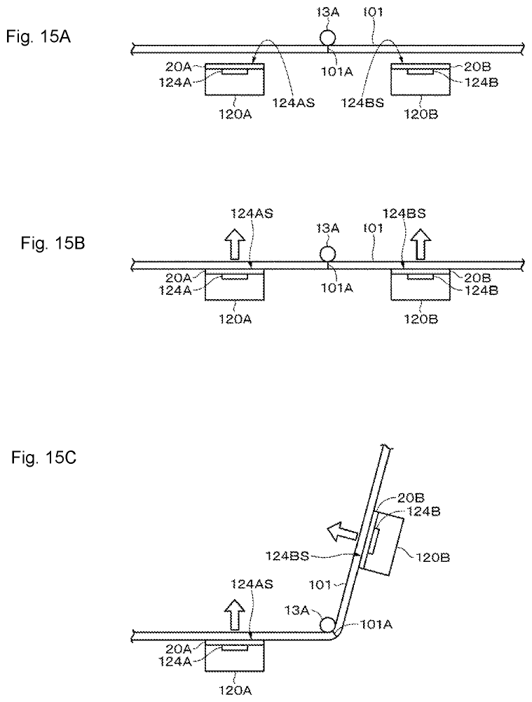

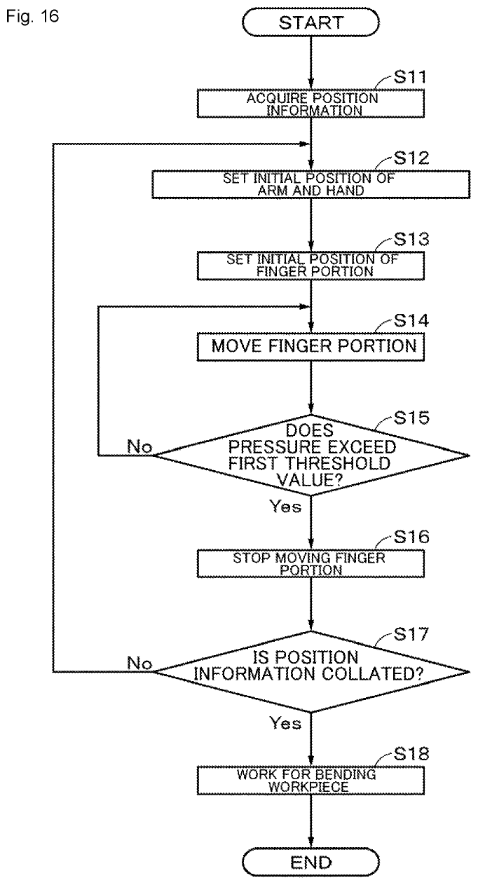

An operation for bending a material (for example, cardboard) 101 of a box as a workpiece will be described as an example of the operation of the robot system according to the first embodiment of the present disclosure with reference to FIGS. 15A, 15B, 15C, and 16. Here, a case in which the material 101 is conveyed from a work position of a previous process to a work position of a bending process by a conveying apparatus such as a belt conveyor, and is conveyed from the work position of the bending process to a work position of the next process after the bending work is completed will be described. A groove-shaped ruled line 101A may be formed on the material 101, as illustrated in FIG. 15A. The ruled line 101A is intended to facilitate bending of the material 101 at the prescribed position.

First, in step S11, when the material 101 is conveyed by the conveying apparatus such as the belt conveyor and stopped at the prescribed position, the control unit 3 controls the camera 13 to photograph the material 101 using the camera 13, and acquires position information of the material 101 from an image obtained by photographing the material 101.

Next, in step S12, the control unit 3 controls the drive units 114A, 114B, 114C, and 114D on the basis of the position information acquired in step S11 to move the robot arm 11 and the robot hand 12 to initial positions. In this case, the control unit 3 controls the drive units 125A and 125B to open the finger portions 120A and 120B. Next, the control unit 3 controls the drive unit 14B to move the jig 14A to a prescribed position (specifically, a position above the ruled line 101A of the material 101).

Next, in step S13, the control unit 3 controls the drive units 125A and 125B to move the finger portions 120A and 120B to the initial positions as illustrated in FIG. 15A. Next, in step S14, the control unit 3 controls the drive units 125A and 125B to move the finger portions 120A and 120B toward the material 101, as illustrated in FIG. 15B.

Next, in step S15, the control unit 3 acquires the pressure distribution of the position sensor 124A via the sensor IC 4A, and determines whether or not the maximum value of the pressure distribution exceeds the first threshold value (see the region R1 in FIG. 4A). Further, in step S15, the control unit 3 acquires the pressure distribution of the position sensor 124B via the sensor IC 4B, and determines whether or not the maximum value of the pressure distribution exceeds the first threshold value (see the region R1 in FIG. 4A).

When a determination is made in step S15 that the maximum value of the pressure distribution of the position sensor 124A exceeds the first threshold value, the control unit 3 stops moving the finger portion 120A in step S16. On the other hand, when a determination is made in step S15 that the maximum value of the pressure distribution of the position sensor 124A does not exceed the first threshold value, the control unit 3 returns the processing to step S14. Accordingly, the movement of the finger portion 120A toward the material 101 is continued.

When a determination is made in step S15 that the maximum value of the pressure distribution of the position sensor 124B exceeds the second threshold value, the control unit 3 stops moving the finger portion 120B in step S16. On the other hand, when a determination is made in step S15 that the maximum value of the pressure distribution of the position sensor 124A does not exceed the first threshold value, the control unit 3 returns the processing to step S14. Accordingly, the movement of the finger portion 120B toward the material 101 is continued.

Next, in step S17, the control unit 3 acquires position information (prescribed position information of the contact regions 122AS and 122BS) from the position sensors 124A and 124B via the sensor ICs 4A and 4B, and performs collation with the position information stored in the storage apparatus 3A (position information of the contact regions 122AS and 122BS). When the position information of both the contact regions 122AS and 122BS are collated in step S17, the control unit 3 proceeds to processing of step S18. On the other hand, when the position information of one or both of the contact regions 122AS and 122BS cannot be collated in step S17, the control unit 3 returns the processing to step S12. Accordingly, the robot arm 11 and the robot hand 12 are returned to initial positions, and the movement of the finger portion 120B toward the material 101 is performed again (see a region R3 in FIG. 4B).

Next, in step S18, the control unit 3 controls the articulated robot 10 to perform the work for bending the material 101, as illustrated in FIG. 15C.

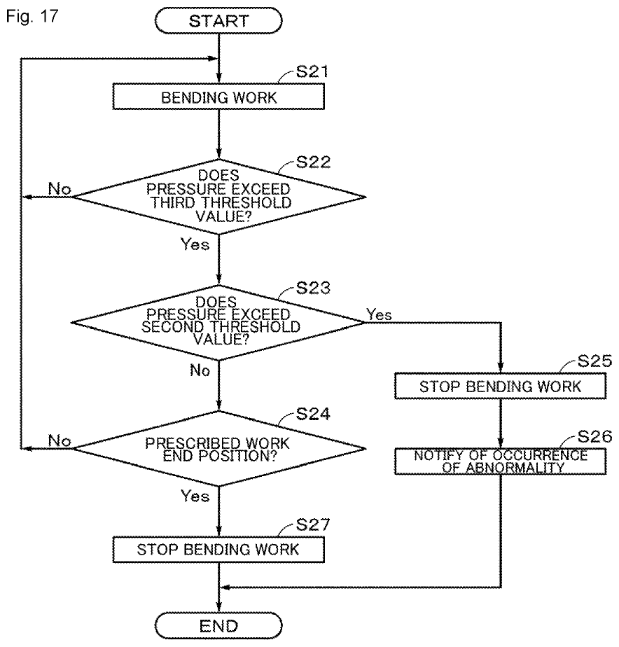

Details of the work for bending the material 101 (step S18) will be described with reference to FIG. 17.

First, in step S21, the control unit 3 controls the drive unit 125B to move the finger portion 120B, thereby bending the material 101 as illustrated in FIG. 15C.

Next, in step S22, the control unit 3 acquires the pressure distribution from the force sensor 20B via the sensor IC 4B, and determines whether or not the maximum value of the pressure distribution exceeds the third threshold value (see the region R2 in FIG. 4A). When a determination is made in step S22 that the maximum value of the pressure distribution exceeds the third threshold value, the control unit 3 proceeds to processing of step S23. On the other hand, when the control unit 3 determines in step S22 that the maximum value of the pressure distribution does not exceed the third threshold value, the control unit 3 returns the processing to step S21. Accordingly, the work for bending the material 101 is continued.

Next, in step S23, the control unit 3 acquires the pressure distribution from the force sensor 20B via the sensor IC 4B, and determines whether or not the maximum value of the pressure distribution exceeds the second threshold value (see the region R4 in FIG. 4B). When the control unit 3 determines in step S23 that the maximum value of the pressure distribution does not exceed the second threshold value, the processing proceeds to step S24. On the other hand, when the control unit 3 determines in step S23 that the maximum value of the pressure distribution exceeds the second threshold value, the control unit 3 stops the work for bending the material 101 in step S25 and then, in step S26, the notification unit 5 notifies the worker of the occurrence of the abnormality.

Next, in step S24, the control unit 3 acquires position information from the position sensor 124B via the sensor IC 4B, and performs collation with the position information (the position information of the contact region 122BS) stored in the storage apparatus 3A. When the position information is collated in step S24, the control unit 3 controls the drive unit 125B to stop the movement of the finger portion 120B, thereby stopping the work for bending the material 101 in step S27. On the other hand, when the position information cannot be collated in step S24, the control unit 3 returns the processing to step S21. Accordingly, the work for bending the material 101 is continued.

[Effects]

In the robot system according to the first embodiment, the robot hand 12 includes the finger portion 120A and the finger portion 120B. The finger portion 120A includes the force sensor (first sensor) 20A configured to be able to detect the pressure distribution of the contact region 122AS that comes into contact with the workpiece, and the position sensor (second sensor) 124A configured to be able to detect the position information of the contact region 122AS. The finger portion 120B includes the force sensor (first sensor) 20B configured to be able to detect the pressure distribution of the contact region 122BS that comes into contact with the workpiece, and the position sensor (second sensor) 124B configured to be able to detect the position information of the contact region 122BS. Accordingly, the control unit 3 can determine whether or not the prescribed pressure is acting on the contact region 122AS of the finger portion 120A at the prescribed position in each operation during work, on the basis of the pressure distribution detected by the force sensor 20A and the position information detected by the position sensor 124A. Similarly, the control unit 3 can determine whether or not the prescribed pressure is acting on the contact region 122BS of the finger portion 120B at the prescribed position in each operation during work, on the basis of the pressure distribution detected by the force sensor 20B and the position information detected by the position sensor 124B. Therefore, even when an actuator capable of performing precise position control for each of the finger portions 120A and 120B is not mounted, it is possible to perform precise work (for example, work for assembling a box or the like).

The force sensors 20A and 20B can detect a three-axis force distribution with a simple and space-saving configuration as a whole. Further, it is possible to detect the three-axis force distribution at any position in an effective region of the sensing surface 20S.

### 2 Second Embodiment

[Configuration of Force Sensor]

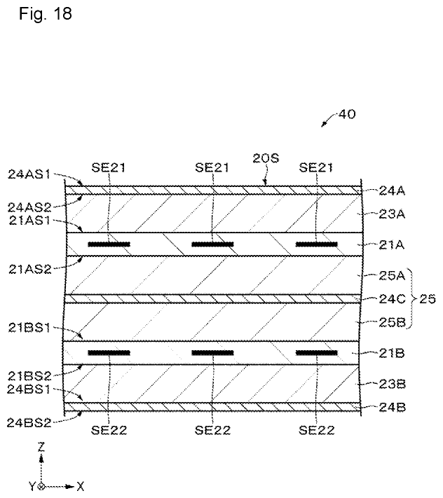

FIG. 18 is a cross-sectional view illustrating an example of a configuration of a force sensor 40 included in a robot hand 12 according to a second embodiment. The robot hand 12 according to the second embodiment includes a force sensor 40 illustrated in FIG. 18 instead of the force sensor 20A (see FIG. 5), and includes a force sensor 40 illustrated in FIG. 18 instead of the force sensor 20B.

The force sensor 40 differs from the force sensor 20 according to the first embodiment in that an isolation layer 25 having a laminated structure is included instead of the isolation layer 22 (see FIG. 5). Further, in the second embodiment, the same locations as the first embodiment are denoted by the same reference signs, and description thereof will be omitted.

(Isolation Layer)

The isolation layer 25 includes a conductive layer (a third conductive layer) 24C, an isolation layer (a first isolation layer) 25A, and an isolation layer (a second isolation layer) 25B. The conductive layer 24C is provided between the isolation layer 25A and the isolation layer 25B. The isolation layer 25A is provided between the detection layer 21A and the conductive layer 24C to isolate the detection layer 21A from the conductive layer 24C. The isolation layer 25B is provided between the detection layer 21B and the conductive layer 24C to isolate the detection layer 21B from the conductive layer 24C. The isolation layer 25A and the isolation layer 25B are configured to be elastically deformable in the in-plane direction of the sensing surface 20S due to shearing force acting in the in-plane direction of the sensing surface 20S (that is, the in-plane direction of the force sensor 20).

A material of the isolation layer 25A and the isolation layer 25B is the same as that of the isolation layer 22 in the first embodiment.

A 25% CLD value of each of the isolation layer 25A and the isolation layer 25B is ten times or more the 25% CLD value of the deformation layer 23A, preferably, 30 times or more the 25% CLD value of the deformation layer 23A, and more preferably, 50 times or more the 25% CLD value of the deformation layer 23A. When the 25% CLD value of each of the isolation layer 25A and the isolation layer 25B is ten times or more the 25% CLD value of the deformation layer 23A, it is possible to improve the detection sensitivity of the sensing portion SE21.

The 25% CLD value of each of the isolation layer 25A and the isolation layer 25B is ten times or more the 25% CLD value of the deformation layer 23B, preferably, 30 times or more the 25% CLD value of the deformation layer 23B and, more preferably, 50 times or more the 25% CLD value of the deformation layer 23B. When the 25% CLD value of each of the isolation layer 25A and the isolation layer 25B is ten times or more the 25% CLD value of the deformation layer 23B, it is possible to improve the detection sensitivity of the sensing portion SE22.

The 25% CLD value of each of the isolation layer 25A and the isolation layer 25B is preferably 500 kPa or less. When the 25% CLD value of each of the isolation layer 25A and the isolation layer 25B exceeds 500 kPa, there is concern that elastic deformation in the in-plane direction of the sensing surface 20S becomes difficult due to the shearing force acting in the in-plane direction of the sensing surface 20S (that is, the in-plane direction of the force sensor 40). Therefore, there is concern that the detection sensitivity of the force sensor 40 for the shearing force in the in-plane direction is degraded.

The 25% CLD value of the isolation layer 25A and the isolation layer 25B is measured according to JIS K 6254.

A total thickness of the isolation layer 25A and the isolation layer 25B is preferably twice or more the thickness of the deformation layer 23A, more preferably four times or more the thickness of the deformation layer 23A, and even more preferably, eight times or more the thickness of the deformation layer 23A. When the total thickness of the isolation layer 25A and the isolation layer 25B is twice or more the thickness of the deformation layer 23A, it is possible to further improve the shearing force detection sensitivity.

The total thickness of the isolation layer 25A and the isolation layer 25B is preferably twice or more the thickness of the deformation layer 23B, more preferably four times or more the thickness of the deformation layer 23B, and even more preferably, eight times or more the thickness of the deformation layer 23B. When the total thickness of the isolation layer 25A and the isolation layer 25B is twice or more the thickness of the deformation layer 23B, it is possible to further improve the shearing force detection sensitivity.

The total thickness of the isolation layer 25A and the isolation layer 25B is preferably 10000 μm or less and, more preferably, 4000 μm or less. When the total thickness of the isolation layer 25A and the isolation layer 25B exceeds 10000 μm, there is concern that it becomes difficult to apply the force sensor 40 to an electronic device or the like.

A thicknesses of the isolation layer 25A and the isolation layer 25B are obtained as in the method for measuring the thickness of the isolation layer 22 in the first embodiment.

A total basis weight of the isolation layer 25A and the isolation layer 25B is preferably ten times or more the basis weight of the deformation layer 23A, and more preferably, 25 times or more the basis weight of the deformation layer 23B. When the total basis weight of the isolation layer 25A and the isolation layer 25B is ten times or more the basis weight of the deformation layer 23A, it is possible to further improve the detection sensitivity of the sensing portion SE21.

The total basis weight of the isolation layer 25A and the isolation layer 25B is preferably ten times or more the basis weight of the deformation layer 23B, and more preferably, 25 times or more the basis weight of the deformation layer 23B. When the total basis weight of the isolation layer 25A and the isolation layer 25B is ten times or more the basis weight of the deformation layer 23B, it is possible to further improve the detection sensitivity of the sensing portion SE22.

The total basis weight of the isolation layer 25A and the isolation layer 25B is preferably 1000 mg/cm² or less. When the total basis weight of the isolation layer 25A and the isolation layer 25B exceeds 1000 mg/cm², there is concern that elastic deformation in the in-plane direction of the sensing surface 20S becomes difficult due to the shearing force acting in the in-plane direction of the sensing surface 20S (that is, the in-plane direction of the force sensor 40).

Therefore, there is concern that the detection sensitivity of the force sensor 40 for the shearing force in the in-plane direction is degraded.

The basis weights of the isolation layer 25A and the isolation layer 25B are obtained as in a method of measuring the basis weight of the isolation layer 22 in the first embodiment.

(Conductive Layer)

The conductive layer 24C is provided between the isolation layer 25A and the isolation layer 25B as described above, to suppress electromagnetic interference between the detection layer 21A and the detection layer 21B. The conductive layer 24C has at least one of flexibility and stretchability. The conductive layer 24C is bent toward the detection layer 21B when pressure acts on the sensing surface 20S. A shape and material of the conductive layer 24C are the same as those of the conductive layer 24A in the first embodiment.

[Operation of Force Sensor]

(Operation of Force Sensor at Time of Pressure Detection)

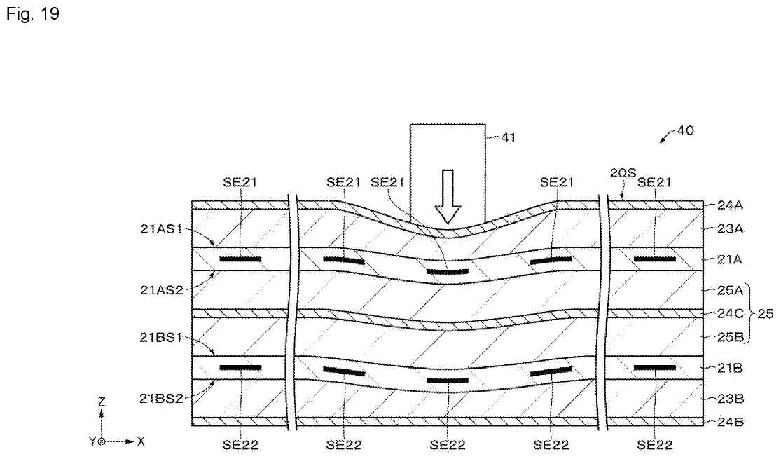

FIG. 19 is a cross-sectional view illustrating an example of an operation of the force sensor 40 at the time of detection of pressure. The operation of the force sensor 40 at the time of detection of pressure is the same as the operation of the force sensor 20 at the time of detection of pressure in the first embodiment, except for the following points. When the sensing surface 20S is pressed by the object 41 and pressure is applied to the first surface 21AS1 of the detection layer 21A by a portion of the crushed deformation layer 23A, the detection layer 21A, the isolation layer 25, and the detection layer 21B are bent toward the conductive layer 24B around the location on which the pressure acts.

(Operation of Force Sensor at Time of Shearing Force Detection)

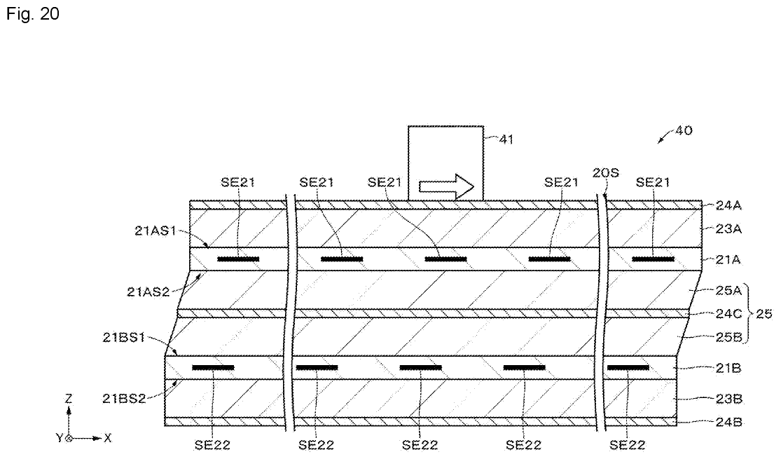

FIG. 20 is a cross-sectional view illustrating an example of the operation of the force sensor 40 at the time of detection of shearing force. The operation of the force sensor 40 at the time of detection of shearing force is the same as the operation of the force sensor 40 at the time of detection of pressure in the first embodiment, except for the following points. When shearing force acts on the force sensor 20, the isolation layer 25A and the isolation layer 25B are elastically deformed in the in-plane direction of the force sensor 20, and relative positions of the detection layer 21A and the detection layer 21B in the in-plane direction of the force sensor 20 are shifted.

[Effects]

The force sensor 40 according to the second embodiment further includes the conductive layer 24C between the detection layer 21A and the detection layer 21B. This makes it possible to further suppress electromagnetic interference between the detection layer 21A and the detection layer 21B. Therefore, the force sensor 40 can suppress a decrease in detection accuracy or erroneous detection as compared with the force sensor 20 according to the first embodiment.

### 3 Third Embodiment

[Configuration of Force Sensor]

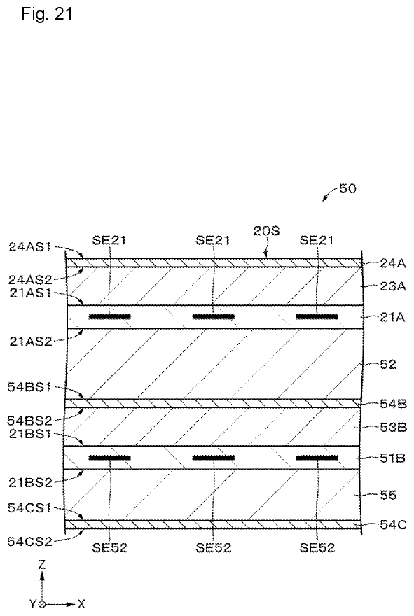

FIG. 21 is a cross-sectional view illustrating an example of a configuration of a force sensor 50 included in a robot hand 12 according to a third embodiment. The robot hand 12 according to the third embodiment includes a force sensor 50 illustrated in FIG. 21 instead of the force sensor 20A (see FIG. 5), and includes a force sensor 50 illustrated in FIG. 21 instead of the force sensor 20B.

The force sensor 50 includes a detection layer (a first detection layer) 21A, a detection layer (a second detection layer) 51B, an isolation layer 52, a deformation layer (a first deformation layer) 23A, a deformation layer (a second deformation layer) 53B, a conductive layer (a first conductive layer) 24A, a conductive layer (a second conductive layer) 54B, a conductive layer (a third conductive layer) 54C, and an adhesive layer 55. The conductive layer 54C and the adhesive layer 55 are included as necessary and may be omitted. Further, in the third embodiment, the same locations as the first embodiment are denoted by the same reference signs, and description thereof will be omitted.

An adhesive layer (not illustrated) is included and bonded between respective layers of the force sensor 50 except for between the detection layer 51B and the adhesive layer 55 and between the conductive layer 54C and the adhesive layer 55. However, when at least one of the two adjacent layers has adhesiveness, the adhesive layer may be omitted.

The detection layer 51B includes a first surface 51BS1 facing the second surface 21AS2 of the detection layer 21A, and a second surface 51BS2 opposite to the first surface 51BS1. The detection layer 21A and the detection layer 51B are disposed in parallel. The conductive layer 54B is provided between the detection layer 21A and the detection layer 51B. The conductive layer 54B is disposed in parallel to the detection layer 21A and the detection layer 51B. The conductive layer 54C is provided to face the second surface 51BS2 of the detection layer 51B. The conductive layer 54B is disposed in parallel to the detection layer 51B. The isolation layer 52 is provided between the detection layer 21A and the conductive layer 54B. The adhesive layer 55 is provided between the detection layer 51B and the conductive layer 54C.

(Detection Layer)

The detection layer 51B is a mutually capacitive detection layer. The detection layer 51B includes a plurality of sensing portions (second sensing portions) SE52. The sensing portion SE52 detects the pressure acting on the sensing surface 20S and outputs a detection result to the sensor IC 4A. Specifically, the sensing portion SE52 detects a capacitance corresponding to a distance between the sensing portion SE52 and the conductive layer 54B, and outputs a detection result to the sensor IC 4A.

The configuration of the detection layer 51B is the same as that of the detection layer 21A in the first embodiment.

(Isolation Layer)

The isolation layer 52 isolates the detection layer 21A from the conductive layer 54B. The isolation layer 52 is elastically deformable in the in-plane direction of the sensing surface 20S due to the shearing force acting in the in-plane direction of the sensing surface 20S (that is, the in-plane direction of the force sensor 50).

A material of the isolation layer 52 is the same as that of the isolation layer 22 in the first embodiment.

A 25% CLD value of the isolation layer 52 is ten times or more the 25% CLD value of the deformation layer 23A, preferably, 30 times or more the 25% CLD value of the deformation layer 23A, and more preferably, 50 times or more the 25% CLD value of the deformation layer 23A. When the 25% CLD value of the isolation layer 52 is ten times or more the 25% CLD value of the deformation layer 23A, it is possible to improve the detection sensitivity of the sensing portion SE21.

The 25% CLD value of the isolation layer 52 is ten times or more the 25% CLD value of the deformation layer 53B, preferably, 30 times or more the 25% CLD value of the deformation layer 53B, and more preferably, 50 times or more the 25% CLD value of the deformation layer 53B. When the 25% CLD value of the isolation layer 52 is ten times or more the 25% CLD value of the deformation layer 53B, it is possible to improve the detection sensitivity of the sensing portion SE52.

The 25% CLD value of the isolation layer 52 is preferably 500 kPa or less. When the 25% CLD value of the isolation layer 52 exceeds 500 kPa, there is concern that elastic deformation in the in-plane direction of the sensing surface 20S becomes difficult due to the shearing force acting in the in-plane direction of the sensing surface 20S (that is, the in-plane direction of the force sensor 50). Therefore, there is concern that the detection sensitivity of the force sensor 50 for the shearing force in the in-plane direction is degraded.

The 25% CLD values of the isolation layer 52 and the deformation layer 53B are measured according to JIS K 6254.

A thickness of the isolation layer 52 is preferably twice or more the thickness of the deformation layer 23A, more preferably, four times or more the thickness of the deformation layer 23A, and even more preferably, eight times or more the thickness of the deformation layer 23A. When the thickness of the isolation layer 52 is twice or more the thickness of the deformation layer 23A, it is possible to further improve the shearing force detection sensitivity.

The thickness of the isolation layer 52 is preferably twice or more the thickness of the deformation layer 53B, more preferably, four times or more the thickness of the deformation layer 23A, and even more preferably, eight times or more the thickness of the deformation layer 53B. When the thickness of the isolation layer 52 is twice or more the thickness of the deformation layer 53B, it is possible to further improve the shearing force detection sensitivity.

The thickness of the isolation layer 52 is preferably 10000 μm or less and, more preferably, 4000 μm or less. When the thickness of the isolation layer 52 exceeds 10000 μm, there is concern that it becomes difficult to apply the force sensor 50 to an electronic device or the like.

Thicknesses of the isolation layer 52 and the deformation layer 53B are obtained as in a method of measuring the thicknesses of the isolation layer 22, the deformation layer 23A, and the deformation layer 23B in the first embodiment.

A basis weight of the isolation layer 52 is preferably ten times or more the basis weight of the deformation layer 23A, and more preferably, 25 times or more the basis weight of the deformation layer 23A. When the basis weight of the isolation layer 52 is ten times or more the basis weight of the deformation layer 23A, it is possible to further improve the detection sensitivity of the sensing portion SE21.

The basis weight of the isolation layer 52 is preferably ten times or more the basis weight of the deformation layer 53B, and more preferably, 25 times or more the basis weight of the deformation layer 53B. When the basis weight of the isolation layer 52 is ten times or more the basis weight of the deformation layer 53B, it is possible to further improve the detection sensitivity of the sensing portion SE52.

The basis weight of the isolation layer 52 is preferably 1000 mg/cm² or less. When the basis weight of the isolation layer 52 exceeds 1000 mg/cm², there is concern that elastic deformation in the in-plane direction of the sensing surface 20S becomes difficult due to the shearing force acting in the in-plane direction of the sensing surface 20S (that is, the in-plane direction of the force sensor 50). Therefore, there is concern that the detection sensitivity of the force sensor 50 for the shearing force in the in-plane direction is degraded.

The basis weights of the isolation layer 52 and the deformation layer 53B are obtained as in the method of measuring the basis weights of the isolation layer 22, the deformation layer 23A, and the deformation layer 23B in the first embodiment.

(Conductive Layer)

The conductive layer 54B has at least one of flexibility and stretchability. The conductive layer 54B is bent toward the detection layer 51B when pressure acts on the sensing surface 20S. The conductive layer 54C may or may not have at least one of flexibility and stretchability, but preferably has at least one of the flexibility and the stretchability so that the force sensor 50 is mounted on a curved surface.

The conductive layer 54B includes a first surface 54BS1 and a second surface 54BS2 opposite to the first surface 54BS1. The second surface 54BS2 faces the first surface 21BS1 of the detection layer 51B. The conductive layer 54C includes a first surface 54CS1, and a second surface 54CS2 opposite to the first surface 54CS1. The first surface 54CS1 faces the second surface 21BS2 of the detection layer 51B.

The conductive layer 54B and the conductive layer 54C are so-called ground electrodes and are connected to the reference potential. Shapes and materials of the conductive layer 54B and the conductive layer 54C are the same as the conductive layer 24A in the first embodiment.

(Deformation Layer)

The deformation layer 53B isolates the detection layer 51B from the conductive layer 54B so that the detection layer 51B and the conductive layer 54B are parallel. It is possible to adjust the sensitivity and dynamic range of the detection layer 51B depending on the thickness of the deformation layer 53B. The deformation layer 53B is configured to be elastically deformable depending on the pressure acting on the sensing surface 20S, that is, the pressure acting in the thickness direction of the force sensor 50.

(Adhesive Layer)

The adhesive layer 55 bonds the detection layer 51B to the conductive layer 54C and isolates the detection layer 51B from the conductive layer 54C. It is possible to adjust the sensitivity and dynamic range of the detection layer 51B depending on a thickness of the adhesive layer 55.

The adhesive layer 55 is, for example, a base material with adhesive layers provided on both surfaces. The adhesive layer 55 may be configured by a plurality of the base materials being laminated.

[Operation of Force Sensor]

(Operation of Force Sensor at Time of Pressure Detection)

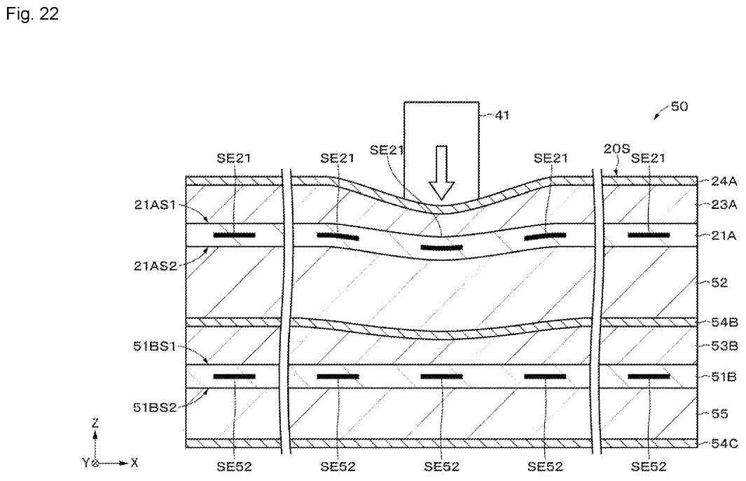

FIG. 22 is a cross-sectional view illustrating an example of an operation of the force sensor 50 at the time of detection of pressure.

When the sensing surface 20S is pressed by the object 41 and pressure acts on the sensing surface 20S, the conductive layer 24A and the detection layer 21A partially approach each other, and the capacitance of the plurality of sensing portions SE21 changes, as in the operation of the force sensor 20 according to the first embodiment.

Further, when the pressure acts on the first surface 21AS1 of the detection layer 21A due to the portion of the deformation layer 23A crushed as described above, the detection layer 21A, the isolation layer 52, and the conductive layer 54B are bent toward the detection layer 51B around the location on which the pressure acts, to crush a portion of the deformation layer 53B. Accordingly, the conductive layer 54B and the detection layer 51B partially approach each other. As a result, some of electric force lines of the plurality of sensing portions SE52 included in a portion of the detection layer 51B approached by the conductive layer 54B (that is, some of the electric force lines between the sense electrode 36 and the pulse electrode 37) flow into the conductive layer 54B, and a capacitance of the sensing portions SE52 changes.

(Operation of Force Sensor at Time of Shearing Force Detection)

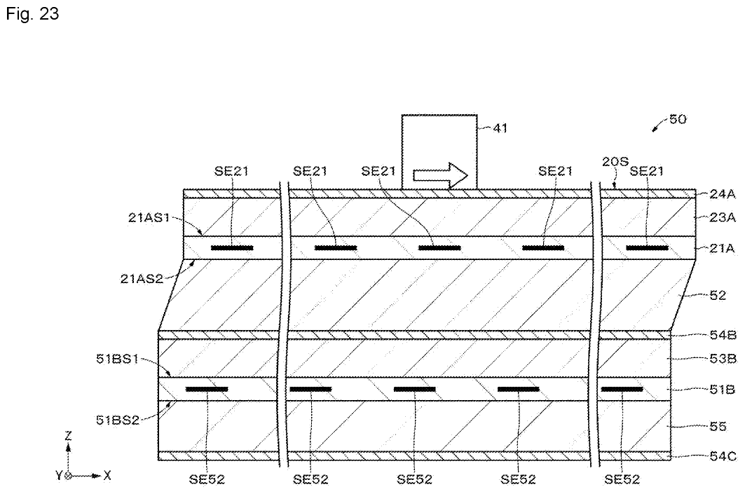

FIG. 23 is a cross-sectional view illustrating an example of an operation of the force sensor 50 at the time of detection of shearing force. When shearing force acts on the force sensor 50, the isolation layer 52 is elastically deformed in the in-plane direction of the force sensor 50, and relative positions of the sensing portion SE21 and the sensing portion SE52 in the in-plane direction (X and Y directions) of the force sensor 50 are shifted. Accordingly, the centroid position of the output signal distribution (a capacitance distribution) of the detection layer 21A and the centroid position of the output signal distribution (a capacitance distribution) of the detection layer 51B are shifted in the in-plane direction (the X and Y directions) of the force sensor 50.

[Effects]

The force sensor 50 according to the third embodiment includes the deformation layer 53B on the detection layer 51B. Therefore, it is possible to improve the pressure and shearing force detection sensitivity, as compared with the force sensor 20 according to the first embodiment including the deformation layer 23B under the detection layer 21B.

### 4 Fourth Embodiment

[Configuration of Force Sensor]

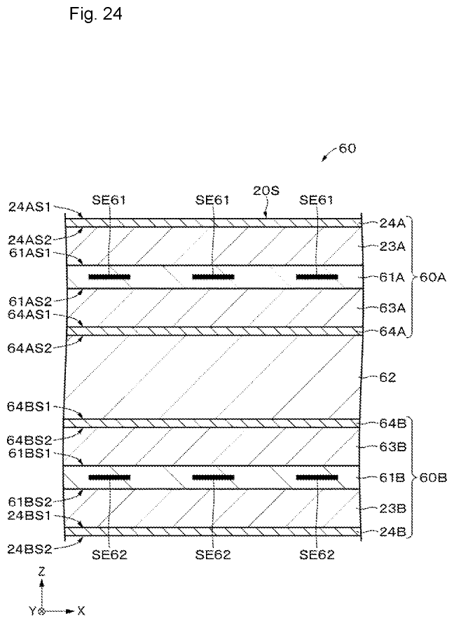

FIG. 24 is a cross-sectional view illustrating an example of a configuration of a force sensor 60 included in a robot hand 12 according to a fourth embodiment. The robot hand 12 according to the fourth embodiment includes the force sensor 60 illustrated in FIG. 24 instead of the force sensor 20A (see FIG. 5), and includes the force sensor 60 illustrated in FIG. 24 instead of the force sensor 20B.

FIG. 24 is a cross-sectional view illustrating an example of the configuration of the force sensor 60 according to the fourth embodiment of the present disclosure. The force sensor 60 includes a detection layer (a first detection layer) 61A, a detection layer (a second detection layer) 61B, an isolation layer 62, a deformation layer (a first deformation layer) 23A, a deformation layer (a second deformation layer) 23B, a deformation layer (a third deformation layer) 63A, a deformation layer (a fourth deformation layer) 63B, a conductive layer (a first conductive layer) 24A, a conductive layer (a second conductive layer) 24B, a conductive layer (a third conductive layer) 64A, and a conductive layer (a fourth conductive layer) 64B. Further, in the fourth embodiment, the same locations as the first embodiment are denoted by the same reference signs, and description thereof will be omitted.

A laminate of the conductive layer 64A, the deformation layer 63A, the detection layer 21A, the deformation layer 23A and the conductive layer 24A constitutes a first force sensor 60A. A laminate of the conductive layer 24B, the deformation layer 23B, the detection layer 61B, the deformation layer 63B, and the conductive layer 64B constitutes a second force sensor 60B.

An adhesive layer (not illustrated) is included and bonded between the respective layers of the force sensor 60. However, when at least one of the two adjacent layers has adhesiveness, the adhesive layer may be omitted.

The detection layer 61A includes a first surface 61AS1, and a second surface 61AS2 opposite to the first surface 61AS1. The detection layer 61B includes a first surface 61BS1 facing the second surface 61AS2, and a second surface 61BS2 opposite to the first surface 61BS1. The detection layer 61A and the detection layer 61B are disposed in parallel. The isolation layer 62 is provided between the detection layer 61A and the detection layer 21B. That is, the isolation layer 62 is provided between the first force sensor 60A and the second force sensor 60B.

The conductive layer 24A is provided to face the first surface 61AS1 of the detection layer 61A. The conductive layer 24A is disposed in parallel to the detection layer 61A. The conductive layer 24B is provided to face the second surface 21BS2 of the detection layer 61B. The conductive layer 24B is disposed in parallel to the detection layer 61B. The conductive layer 64A is provided between the detection layer 61A and the isolation layer 62. The conductive layer 64A is disposed in parallel to the detection layer 61A. The conductive layer 64B is provided between the detection layer 61B and the isolation layer 62. The conductive layer 64B is disposed in parallel to the detection layer 61B. The deformation layer 23A is provided between the detection layer 61A and the conductive layer 24A. The deformation layer 23B is provided between the detection layer 61B and the conductive layer 24B. The deformation layer 63A is provided between the detection layer 61A and the conductive layer 64A. The deformation layer 63B is provided between the detection layer 61B and the conductive layer 64B.

(Detection Layer)

The detection layer 61A and the detection layer 61B are mutually capacitive detection layers. The detection layer 61A has flexibility. The detection layer 61A is bent toward the conductive layer 64A when pressure acts on the sensing surface 20S. The detection layer 61A includes a plurality of sensing portions (first sensing portions) SE61. The sensing portion SE61 detects the pressure acting on the sensing surface 20S and outputs a detection result to the sensor IC 4A. Specifically, the sensing portion SE61 detects a capacitance corresponding to a distance between the sensing portion SE61 and the conductive layer 24A and a distance between the sensing portion SE21 and the conductive layer 64A, and outputs a detection result to the sensor IC 4A.

The detection layer 61B has flexibility. The detection layer 61B is bent toward the conductive layer 24B when pressure acts on the sensing surface 20S. The detection layer 61B includes a plurality of sensing portions (second sensing portions) SE62. The sensing portion SE62 detects the pressure acting on the sensing surface 20S and outputs a detection result to the sensor IC 4A.

Specifically, the sensing portion SE62 detects a capacitance corresponding to a distance between the sensing portion SE62 and the conductive layer 64B and a distance between the sensing portion SE62 and the conductive layer 24B, and outputs a detection result to the sensor IC 4A.

The detection layer 61A and the detection layer 61B have the same configuration as the detection layer 21A in the first embodiment.

(Isolation Layer)

The isolation layer 62 isolates the conductive layer 64A from the conductive layer 64B. That is, the isolation layer 62 isolates the first force sensor 60A from the second force sensor 60B. The isolation layer 62 is configured to be elastically deformable in the in-plane direction of the sensing surface 20S due to the shearing force acting in the in-plane direction of the sensing surface 20S (that is, the in-plane direction of the force sensor 20).

A material of the isolation layer 62 is the same as that of the isolation layer 22 in the first embodiment.

A 25% CLD value of the isolation layer 62 is ten times or more the 25% CLD value of the deformation layer 23A, preferably, 30 times or more the 25% CLD value of the deformation layer 23A, and more preferably, 50 times or more the 25% CLD value of the deformation layer 23A. When the 25% CLD value of the isolation layer 62 is ten times or more the 25% CLD value of the deformation layer 23A, it is possible to improve the detection sensitivity of the sensing portion SE61.

The 25% CLD value of the isolation layer 62 is ten times or more the 25% CLD value of the deformation layer 63A, preferably, 30 times or more the 25% CLD value of the deformation layer 63A, and more preferably, 50 times or more the 25% CLD value of the deformation layer 63A. When the 25% CLD value of the isolation layer 62 is ten times or more the 25% CLD value of the deformation layer 63A, it is possible to improve the detection sensitivity of the sensing portion SE61.

The 25% CLD value of the isolation layer 62 is ten times or more the 25% CLD value of the deformation layer 23B, preferably, 30 times or more the 25% CLD value of the deformation layer 23B and, more preferably, 50 times or more the 25% CLD value of the deformation layer 23B. When the 25% CLD value of the isolation layer 62 is ten times or more the 25% CLD value of the deformation layer 23B, it is possible to improve the detection sensitivity of the sensing portion SE62.

The 25% CLD value of the isolation layer 62 is ten times or more the 25% CLD value of the deformation layer 63B, preferably, 30 times or more the 25% CLD value of the deformation layer 63B, and more preferably, 50 times or more the 25% CLD value of the deformation layer 63B. When the 25% CLD value of the isolation layer 62 is ten times or more the 25% CLD value of the deformation layer 63B, it is possible to improve the detection sensitivity of the sensing portion SE62.

The 25% CLD value of the isolation layer 62 is preferably 500 kPa or less. When the 25% CLD value of the isolation layer 62 exceeds 500 kPa, there is concern that elastic deformation in the in-plane direction of the sensing surface 20S becomes difficult due to the shearing force acting in the in-plane direction of the sensing surface 20S (that is, the in-plane direction of the force sensor 60). Therefore, there is concern that the detection sensitivity of the force sensor 60 for the shearing force in the in-plane direction is degraded.

The 25% CLD values of the isolation layer 62, the deformation layer 63A, and the deformation layer 63B are measured according to JIS K 6254.

A thickness of the isolation layer 62 is preferably twice or more the thickness of the deformation layer 23A, more preferably, four times or more the thickness of the deformation layer 23A, and even more preferably, eight times or more the thickness of the deformation layer 23A. When the thickness of the isolation layer 22 is twice or more the thickness of the deformation layer 23A, it is possible to further improve the shearing force detection sensitivity.

The thickness of the isolation layer 62 is preferably twice or more the thickness of the deformation layer 63A, more preferably, four times or more the thickness of the deformation layer 63A, and even more preferably, eight times or more the thickness of the deformation layer 63A. When the thickness of the isolation layer 62 is twice or more the thickness of the deformation layer 63A, it is possible to further improve the shearing force detection sensitivity.

The thickness of the isolation layer 62 is preferably twice or more the thickness of the deformation layer 23B, more preferably, four times or more the thickness of the deformation layer 23B, and even more preferably, eight times or more the thickness of the deformation layer 23B. When the thickness of the isolation layer 62 is twice or more the thickness of the deformation layer 23B, it is possible to further improve the shearing force detection sensitivity.

The thickness of the isolation layer 62 is preferably twice or more the thickness of the deformation layer 63B, more preferably, four times or more the thickness of the deformation layer 63B, and even more preferably, eight times or more the thickness of the deformation layer 63B. When the thickness of the isolation layer 62 is twice or more the thickness of the deformation layer 63B, it is possible to further improve the shearing force detection sensitivity.

The thickness of the isolation layer 62 is preferably 10000 μm or less and, more preferably, 4000 μm or less. When the thickness of the isolation layer 62 exceeds 10000 μm, there is concern that it becomes difficult to apply the force sensor 60 to an electronic device or the like.

Thicknesses of the isolation layer 62, the deformation layer 63A, and the deformation layer 63B are obtained as in a method of measuring the thicknesses of the isolation layer 22, the deformation layer 23A, and the deformation layer 23B in the first embodiment.

A basis weight of the isolation layer 62 is preferably ten times or more the basis weight of the deformation layer 23A, and, more preferably 25 times or more the basis weight of the deformation layer 23A. When the basis weight of the isolation layer 62 is ten times or more the basis weight of the deformation layer 23A, it is possible to further improve the detection sensitivity of the sensing portion SE61.

The basis weight of the isolation layer 62 is preferably ten times or more the basis weight of the deformation layer 63A and, more preferably, 25 times or more the basis weight of the deformation layer 63A. When the basis weight of the isolation layer 62 is ten times or more the basis weight of the deformation layer 63A, it is possible to further improve the detection sensitivity of the sensing portion SE61.

The basis weight of the isolation layer 62 is preferably ten times or more the basis weight of the deformation layer 23B, and more preferably, 25 times or more the basis weight of the deformation layer 23B. When the basis weight of the isolation layer 62 is ten times or more the basis weight of the deformation layer 23B, it is possible to further improve the detection sensitivity of the sensing portion SE62.

The basis weight of the isolation layer 62 is preferably ten times or more the basis weight of the deformation layer 63B and, more preferably, 25 times or more the basis weight of the deformation layer 63B. When the basis weight of the isolation layer 62 is ten times or more the basis weight of the deformation layer 63B, it is possible to further improve the detection sensitivity of the sensing portion SE62.

The basis weight of the isolation layer 62 is preferably 1000 mg/cm² or less. When the basis weight of the isolation layer 62 exceeds 1000 mg/cm², there is concern that elastic deformation in the in-plane direction of the sensing surface 20S becomes difficult due to the shearing force acting in the in-plane direction of the sensing surface 20S (that is, the in-plane direction of the force sensor 60). Therefore, there is concern that the detection sensitivity of the force sensor 60 for the shearing force in the in-plane direction is degraded.

The basis weights of the isolation layer 62, the deformation layer 63A, and the deformation layer 63B are obtained as in the method of measuring the basis weights of the isolation layer 22, the deformation layer 23A, and the deformation layer 23B in the first embodiment.

(Conductive Layer)

The conductive layer 64A has at least one of flexibility and stretchability. The conductive layer 64A is bent toward the detection layer 61B when pressure acts on the sensing surface 20S. The conductive layer 64B has at least one of flexibility and stretchability. The conductive layer 64B is bent toward the detection layer 61B when pressure acts on the sensing surface 20S.

The conductive layer 64A includes a first surface 64AS1 and a second surface 64AS2 opposite to the first surface 64AS1. The first surface 64AS1 faces the second surface 61AS2 of the detection layer 61A. The conductive layer 64B includes a first surface 64BS1 and a second surface 64BS2 opposite to the first surface 64BS1. The second surface 64BS2 faces the first surface 61BS1 of the detection layer 61B.

The conductive layer 64A and the conductive layer 64B are so-called ground electrodes and are connected to the reference potential. A shape and material of the conductive layer 64A and the conductive layer 64B are the same as the shape and material of the conductive layer 24A in the first embodiment.

(Deformation Layer)

The deformation layer 63A isolates the detection layer 61A from the conductive layer 62A so that the detection layer 61A and the conductive layer 64A are parallel. It is possible to adjust the sensitivity and dynamic range of the detection layer 61A depending on the thickness of the deformation layer 63A. The deformation layer 63A is configured to be elastically deformable depending on the pressure acting on the sensing surface 20S, that is, the pressure acting in the thickness direction of the force sensor 60.

The deformation layer 63B isolates the detection layer 61B from the conductive layer 64B so that the detection layer 61B and the conductive layer 64B are parallel. It is possible to adjust the sensitivity and dynamic range of the detection layer 61B depending on the thickness of the deformation layer 63B. The deformation layer 63B is configured to be elastically deformable depending on the pressure acting on the sensing surface 20S, that is, the pressure acting in the thickness direction of the force sensor 60.

Materials of the deformation layers 63A and 63B are the same as those of the deformation layer 23A in the first embodiment.

[Operation of Force Sensor]

(Operation of Force Sensor at Time of Pressure Detection)

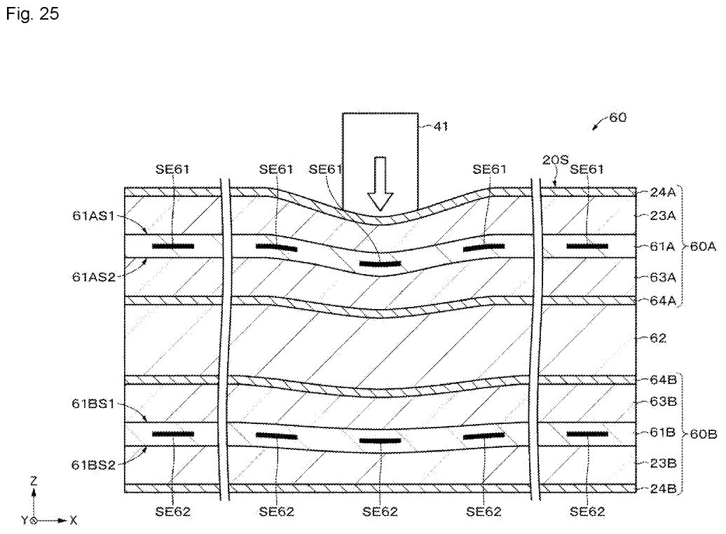

FIG. 25 is a cross-sectional view illustrating an example of an operation of the force sensor 60 at the time of detection of pressure. When the sensing surface 20S is pressed by the object 41 and pressure acts on the sensing surface 20S, the conductive layer 24A and the detection layer 61A partially approach each other, as in the operation of the force sensor 20 in the first embodiment. Further, when the pressure acts on the first surface 61AS1 of the detection layer 61A due to the portion of the deformation layer 23A crushed by the conductive layer 24A, the detection layer 61A is bent toward the conductive layer 64A around the location on which the pressure acts, to crush a portion of the deformation layer 63A. Accordingly, the detection layer 61A and the conductive layer 64A partially approach each other.

As described above, the conductive layer 24A and the detection layer 61A partially approach each other and the detection layer 61A and the conductive layer 64A partially approach each other, so that some of electric force lines of the plurality of sensing portions SE61 included in a portion of the detection layer 61A that has approached the conductive layer 24A and the conductive layer 64A (that is, some of the electric force lines between the sense electrode 36 and the pulse electrode 37) flow into the conductive layer 24A and the conductive layer 64A, and a capacitance of the sensing portions SE61 changes.

When pressure is applied to the first surface of the conductive layer 64A by a portion of the deformation layer 63A crushed as described above, the conductive layer 64A, the isolation layer 62, and the conductive layer 64B are bent toward the detection layer 61B around the location on which the pressure acts, to crush a portion of the deformation layer 63B. Accordingly, the conductive layer 64B and the detection layer 61B partially approach each other. Further, when the pressure acts on the first surface 61BS1 of the detection layer 61B due to the portion of the deformation layer 63B crushed as described above, the detection layer 61B is bent toward the conductive layer 24B around the location on which the pressure acts, to crush a portion of the deformation layer 23B. Accordingly, the detection layer 61B and the conductive layer 24B partially approach each other.

As described above, the conductive layer 64B and the detection layer 61B partially approach each other and the detection layer 61B and the conductive layer 24B partially approach each other, so that some of electric force lines of the plurality of sensing portions SE62 included in a portion of the detection layer 61B that has approached the conductive layer 64B and the conductive layer 24B (that is, some of the electric force lines between the sense electrode 36 and the pulse electrode 37) flow into the conductive layer 64B and the conductive layer 24B, and a capacitance of the plurality of sensing portions SE62 changes.

(Operation of Force Sensor at Time of Shearing Force Detection)

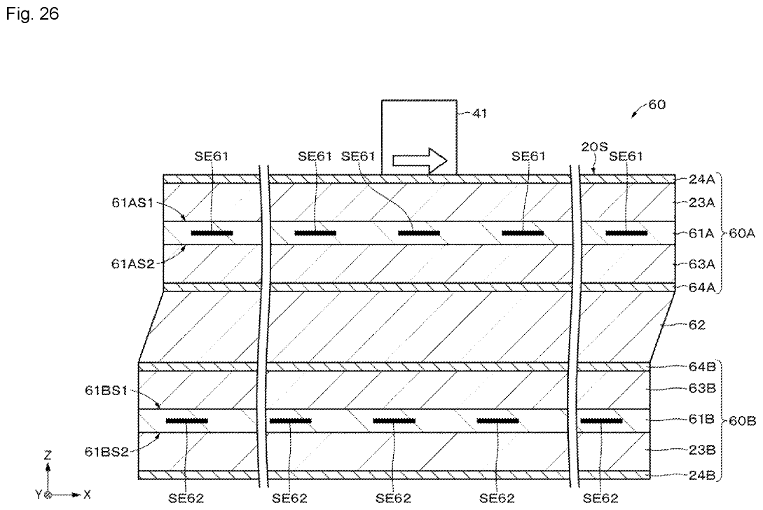

FIG. 26 is a cross-sectional view illustrating an example of an operation of the force sensor 60 at the time of detection of shearing force. When shearing force acts on the force sensor 60, the isolation layer 62 is elastically deformed in the in-plane direction of the force sensor 60, and relative positions of the sensing portion SE61 and the sensing portion SE62 in the in-plane direction (the X and Y directions) of the force sensor 60 are shifted. Accordingly, the centroid position of the output signal distribution (a capacitance distribution) of the detection layer 61A and the centroid position of the output signal distribution (a capacitance distribution) of the detection layer 61B are shifted in the in-plane direction (the X and Y directions) of the force sensor 60.

[Effects]

The force sensor 60 according to the fourth embodiment includes the conductive layer 24A and the conductive layer 64A on the first surface 61AS1 side and the second surface 61AS2 side of the detection layer 61A. Further, the conductive layer 24B and the conductive layer 64B are included on the first surface 61BS1 side and the second surface 61BS2 side of the detection layer 61B. Therefore, it is possible to make the detection sensitivity of sensing portion SE61 and the sensing portion SE62 higher than the detection sensitivity of sensing portion SE21 and sensing portion SE22 in the first embodiment. Therefore, with the force sensor 60, the detection sensitivity higher than that of the force sensor 20 according to the first embodiment can be obtained.

Further, the force sensor 60 according to the fourth embodiment can be configured by the isolation layer 62 being interposed between the first force sensor 60A and the second force sensor 60B having the same structure. Therefore, it is possible to detect a three-axis force distribution with a relatively simple and space-saving configuration as a whole, similarly to the force sensor 20 according to the first embodiment.

### 5 Fifth Embodiment

[Configuration of Force Sensor]

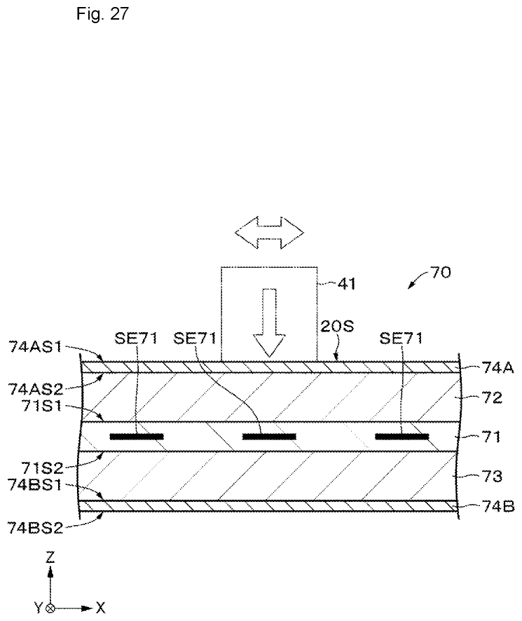

FIG. 27 is a cross-sectional view illustrating an example of a configuration of a force sensor 70 included in a robot hand 12 according to a fifth embodiment. The robot hand 12 according to the fifth embodiment includes a force sensor 70 illustrated in FIG. 27 instead of the force sensor 20A (see FIG. 5), and includes a force sensor 70 illustrated in FIG. 27 instead of the force sensor 20B.

The force sensor 70 includes a detection layer 71, an isolation layer 72, a deformation layer 73, a conductive layer 74A, and a conductive layer 74B.

The detection layer 71 includes a first surface 71S1 and a second surface 71S2 opposite to the first surface 71S1. The conductive layer 74A is provided to face the first surface 71S1 of the detection layer 71. The conductive layer 74A is disposed in parallel to the detection layer 71.

The conductive layer 74B is provided to face the second surface 71S2 of the detection layer 71. The conductive layer 74B is disposed in parallel to the detection layer 71. The isolation layer 72 is provided between the detection layer 71 and the conductive layer 74A. The deformation layer 73 is provided between the detection layer 71 and the conductive layer 74B.

(Detection Layer)

The detection layer 71 is a mutually capacitive detection layer. The detection layer 71 has flexibility. The detection layer 71 is bent toward the conductive layer 74B when pressure acts on the sensing surface 20S. The detection layer 71 includes a plurality of sensing portions SE71. The sensing portion SE71 detects the pressure acting on the sensing surface 20S and outputs a detection result to the sensor IC 4A. Specifically, the sensing portion SE71 detects a capacitance corresponding to a distance between the sensing portion SE71 and the conductive layer 74B, and outputs a detection result to the sensor IC 4A.

The detection layer 71 has the same configuration as the detection layer 21A in the first embodiment.

(Isolation Layer)

The isolation layer 72 isolates the detection layer 71 from the conductive layer 74A so that the detection layer 71 and the conductive layer 74A are parallel. The isolation layer 72 is configured to be elastically deformable in the in-plane direction of the sensing surface 20S due to shearing force acting in the in-plane direction of the sensing surface 20S (that is, the in-plane direction of the force sensor 20).

A material of the isolation layer 72 is the same as that of the isolation layer 22 in the first embodiment.

The 25% CLD value of the isolation layer 72 is ten times or more the 25% CLD value of the deformation layer 73, preferably, 30 times or more the 25% CLD value of the deformation layer 73 and, more preferably, 50 times or more the 25% CLD value of the deformation layer 73. When the 25% CLD value of the isolation layer 72 is ten times or more the 25% CLD value of the deformation layer 73, it is possible to improve the pressure and shearing force detection sensitivity of the force sensor 70.

The 25% CLD value of the isolation layer 72 is preferably 500 kPa or less. When the 25% CLD value of the isolation layer 72 exceeds 500 kPa, there is concern that elastic deformation in the in-plane direction of the sensing surface 20S becomes difficult due to the shearing force acting in the in-plane direction of the sensing surface 20S (that is, the in-plane direction of the force sensor 70). Therefore, there is concern that the detection sensitivity of the force sensor 70 for the shearing force in the in-plane direction is degraded.

25% CLD values of the isolation layer 72 and the deformation layer 73 are measured according to JIS K 6254.

A thickness of the isolation layer 72 is preferably twice or more the thickness of the deformation layer 73, more preferably, four times or more the thickness of the deformation layer 73, and even more preferably, eight times or more the thickness of the deformation layer 23A. When the thickness of the isolation layer 72 is twice or more the thickness of the deformation layer 73, it is possible to further improve the shearing force detection sensitivity of the force sensor 70.

The thickness of the isolation layer 72 is preferably 10000 μm or less and, more preferably, 4000 μm or less. When the thickness of the isolation layer 72 exceeds 10000 μm, there is concern that it becomes difficult to apply the force sensor 70 to an electronic device or the like.

The thicknesses of the isolation layer 72 and the deformation layer 73 are obtained as in a method of measuring the thicknesses of the isolation layer 22, the deformation layer 23A, and the deformation layer 23B in the first embodiment.

The basis weight of the isolation layer 72 is preferably ten times or more the basis weight of the deformation layer 73, and more preferably, 25 times or more the basis weight of the deformation layer 73. When the basis weight of the isolation layer 72 is ten times or more the basis weight of the deformation layer 73, it is possible to further improve the pressure and shearing force detection sensitivity of the force sensor 70.

The basis weight of the isolation layer 72 is preferably 1000 mg/cm² or less. When the basis weight of the isolation layer 72 exceeds 1000 mg/cm², there is concern that elastic deformation in the in-plane direction of the sensing surface 20S becomes difficult due to the shearing force acting in the in-plane direction of the sensing surface 20S (that is, the in-plane direction of the force sensor 70). Therefore, there is concern that the detection sensitivity of the force sensor 70 for the shearing force in the in-plane direction is degraded.

The basis weights of the isolation layer 72 and the deformation layer 73 are obtained as in the method of measuring the basis weights of the isolation layer 22, the deformation layer 23A, and the deformation layer 23B in the first embodiment.

(Conductive Layer)

The conductive layer 74A has at least one of flexibility and stretchability. The conductive layer 74A is bent toward the detection layer 71 when pressure acts on the sensing surface 20S. The conductive layer 74B may or may not have at least one of flexibility and stretchability, but preferably has at least one of the flexibility and the stretchability so that the force sensor 70 is mounted on a curved surface.

The conductive layer 74A includes a first surface 74AS1 and a second surface 74AS2 opposite to the first surface 74AS1. The second surface 74AS2 faces the first surface 71S1 of the detection layer 71. The conductive layer 74B includes a first surface 74BS1 and a second surface 74BS2 opposite to the first surface 74BS1. The first surface 74BS1 faces the second surface 71S2 of the detection layer 71.

The conductive layer 74A and the conductive layer 74B are so-called ground electrodes and are connected to the reference potential. A shape and material of the conductive layer 74A and the conductive layer 74B are the same as the shape and material of the conductive layer 24A in the first embodiment.

(Deformation Layer)

The deformation layer 73 isolates the detection layer 71 from the conductive layer 74B so that the detection layer 71 and the conductive layer 74B are parallel. It is possible to adjust the sensitivity and dynamic range of the detection layer 71 depending on the thickness of the deformation layer 73.

The deformation layer 73 is configured to be elastically deformable depending on the pressure acting on the sensing surface 20S, that is, the pressure acting in the thickness direction of the force sensor 70. A material of the deformation layer 73 is the same as that of the deformation layer 23A in the first embodiment.

[Operation of Force Sensor]

(Operation of Force Sensor at Time of Pressure Detection)

When the sensing surface 20S is pressed by the object 41 and pressure acts on the sensing surface 20S, the conductive layer 74A, the isolation layer 72, and the detection layer 71 are bent toward conductive layer 74B around the location on which the pressure acts, to crush a portion of the deformation layer 73 deforms. Accordingly, the detection layer 71 and the conductive layer 74B partially approach each other. As a result, some of electric force lines of the plurality of sensing portions SE71 included in a portion of the detection layer 71 that has approached the conductive layer 74A (that is, some of the electric force lines between the sense electrode 36 and the pulse electrode 37) flow into the conductive layer 74A, and a capacitance of the plurality of sensing portions SE71 changes.

(Operation of Force Sensor at Time of Shearing Force Detection)

When the shearing force acts on the force sensor 70, the isolation layer 72 is elastically deformed in the in-plane direction of the force sensor 70, and a position on which pressure acts in the sensing surface 20S is shifted in the in-plane direction of the force sensor 70. The control unit 3 can detect change in signal distribution in the in-plane direction of the force sensor 70 in time series to detect the shearing force.

[Effects]

The force sensor 50 according to the fifth embodiment can detect three-axis forces with a simpler configuration than the force sensor 20 according to the first embodiment.

### 6 Sixth Embodiment

[Configuration of Force Sensor]

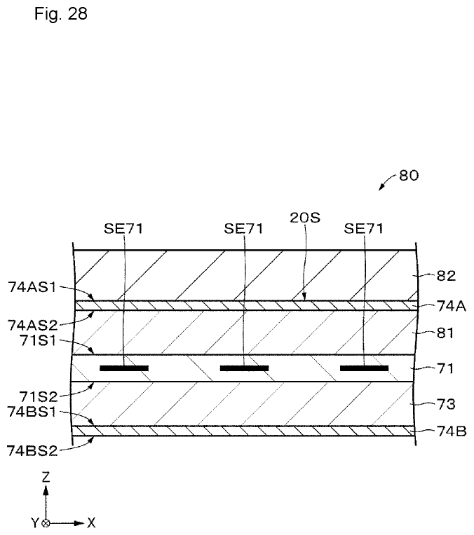

FIG. 28 is a cross-sectional view illustrating an example of a configuration of a force sensor 80 included in a robot hand 12 according to a sixth embodiment. The robot hand 12 according to the sixth embodiment includes a force sensor 80 illustrated in FIG. 28 instead of the force sensor 20A (see FIG. 5), and a force sensor 80 illustrated in FIG. 28 instead of the force sensor 20B.

The force sensor 80 is configured to be able to detect the pressure distribution of the contact region 122AS. The force sensor 80 differs from the force sensor 70 according to the fifth embodiment in that a deformation layer 81 is included instead of the isolation layer 72 (see FIG. 27). The force sensor 80 may include an exterior material 82 on the first surface 74AS1 of the conductive layer 74A. Further, in the sixth embodiment, the same locations as those the fifth embodiment are denoted by the same reference sign, and description thereof will be omitted.

The deformation layer 81 has the same function and configuration as the deformation layer 23A in the first embodiment. The exterior material 82 has flexibility. The exterior material 82 is bent toward the detection layer 71 when pressure acts on a surface. The exterior material 82 includes, for example, at least one selected from a group consisting of a polymer resin layer, a metal layer, and a metal oxide layer.

[Operation of Force Sensor]

(Operation of Force Sensor at Time of Pressure Detection)

When the surface of the exterior material 82 is pressed by the object 41 and pressure acts on the sensing surface 20S, the conductive layer 74A is bent toward the detection layer 71 around the location on which the pressure acts, to crush a portion of the deformation layer 81. Accordingly, the conductive layer 74A and the detection layer 71 partially approach each other. As a result, some of electric force lines of the plurality of sensing portions SE71 included in a portion of the detection layer 71 that has approached the conductive layer 74 flow into the conductive layer 74A, and a capacitance of the plurality of sensing portions SE71 changes.

Further, the pressure acts on the first surface 71S1 of the detection layer 71 due to the portion of the deformation layer 81 crushed as described above, and the detection layer 71 is bent toward the conductive layer 74B around the location on which the pressure acts. Accordingly, the detection layer 71 and the conductive layer 74B partially approach each other. As a result, some of electric force lines of the plurality of sensing portions SE71 included in a portion of the detection layer 71 that has approached the conductive layer 74B flow into the conductive layer 74B, and a capacitance of the plurality of sensing portions SE71 changes.

The sensor IC 4A sequentially scans the plurality of sensing portions SE71 included in the detection layer 71, and acquires the output signal distribution, that is, the capacitance distribution from the plurality of sensing portions SE21. The sensor IC 4A outputs the acquired output signal distribution to the control unit 3. The control unit 3 calculates the magnitude of the pressure and the position on which the pressure acts, on the basis of the output signal distribution received from the sensor IC 4A.

### 7 Modification Examples

### Modification Example 1

In the first embodiment, an example in which the present disclosure is applied to a vertical articulated robot has been described, but robots to which the present disclosure can be applied are not limited to this example. For example, it is also possible to apply the present disclosure to dual-arm robots, parallel sink robots, or the like.

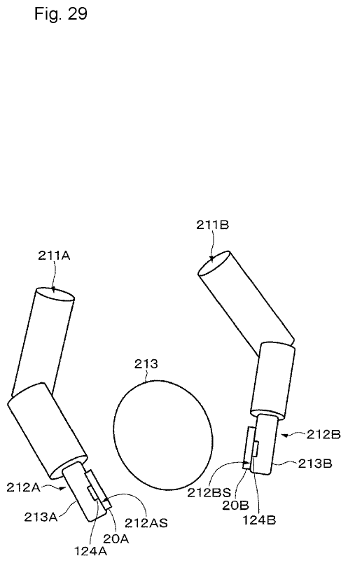

FIG. 29 is a schematic diagram illustrating an example of a configuration of a dual-arm robot. The dual-arm robot includes a robot arm 211A, a robot arm 211B, a robot hand 212A, a robot hand 212B, and a body (not illustrated). The robot arm 211A and the robot arm 211B are attached to the body. The robot hand 212A is provided at a tip of the robot arm 211A. The robot hand 212B is provided at a tip of the robot arm 211B.

The robot hand 212A includes a palm portion 213A, a force sensor 20A, and a position sensor 124A. The palm portion 213A includes a contact region 212AS that comes into contact with the workpiece at the time of prescribed work. The force sensor 20A and the position sensor 124A are provided in the contact region 212AS. The force sensor 20A detects the pressure distribution and shearing force applied to the contact region 212AS under the control of the sensor IC 4A, and outputs a detection result to the sensor IC 4A. The position sensor 124A detects the position of the contact region 212AS (for example, a center position of the contact region 212AS) under the control of the sensor IC 4A, and outputs a detection result to the sensor IC 4A.

The robot hand 212B includes a palm portion 213B, a force sensor 20B, and a position sensor 124B. The palm portion 213B includes a contact region 212BS that comes into contact with the workpiece at the time of prescribed work. The force sensor 20B and the position sensor 124B are provided in the contact region 212BS. The force sensor 20B detects the pressure distribution and shearing force applied to the contact region 212BS under the control of the sensor IC 4B, and outputs a detection result to the sensor IC 4B. The position sensor 124B detects the position of the contact region 212BS (for example, a center position of the contact region 212BS) under the control of the sensor IC 4B, and outputs a detection result to the sensor IC 4B.

In the dual-arm robot having the above configuration, the workpiece 213 is gripped by the palm portion 213A and the palm portion 213B.

### Modification Example 2

Although an example in which the robot system includes the jig apparatus 14 has been described in the first embodiment, the jig apparatus 14 is included as necessary, and the robot system may not include the jig apparatus 14.

### Modification Example 3

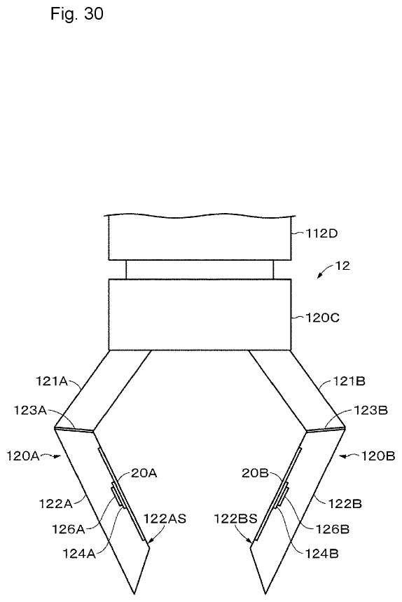

As illustrated in FIG. 30, the finger portion 120A may further include an angle sensor (a third sensor) 126A in the contact region 122AS, and the finger portion 120B may further include an angle sensor (a third sensor) 126B in the contact region 122BS.

Although an example in which the finger portion 120A separately includes the position sensor 124A and the angle sensor 126A will be described in the present modification example 3, a position angle sensor having both functions of the position sensor 124A and the angle sensor 126A may be included in the contact region 122AS. Further, although an example in which the finger portion 120B separately includes the position sensor 124B and the angle sensor 126B will be described in the present modification example 3, a position angle sensor having both functions of the position sensor 124B and the angle sensor 126B may be included in the contact region 122BS.

The angle sensor 126A is configured to detect angle information of the contact region 122AS. More specifically, the angle sensor 126A is a three-axis angle sensor, and measures a three-dimensional angle (an attitude angle of the contact region 122AS) in a normal direction of the contact region 122AS under the control of the sensor IC 4A. A specific example of the angle sensor 126A may include a geomagnetic sensor.

The angle sensor 126B is configured to be able to detect angle information of the contact region 122BS. More specifically, the angle sensor 126B is a 3-axis angle sensor, and measures a three-dimensional angle (attitude angle of the contact region 122BS) in a normal direction of the contact region 122BS under the control of the sensor IC 4B. A specific example of the angle sensor 126B may include a geomagnetic sensor.

The angle sensor 126A may be provided on a substrate (for example, a flexible printed substrate constituting the detection layer 21A) included in the force sensor 20A. The angle sensor 126B may be provided on a substrate (for example, a flexible printed substrate constituting the detection layer 21A) included in the force sensor 20B.

Further, the storage apparatus 3A may further store the angle information of the contact region 122AS and the angle information of the contact region 122BS. The angle information of the contact region 122AS is three-dimensional angle information (attitude angle information of the contact region 122AS) in the normal direction of the contact region 122AS. The angle information of the contact region 122BS is three-dimensional angle information (attitude angle information of the contact region 122BS) in the normal direction of the contact region 122BS.

The sensor IC 4A controls the angle sensor 126A to detect the angle information of the contact region 122AS, and outputs a detection result to the control unit 3. The sensor IC 4B controls the angle sensor 126B to detect the angle information of the contact region 122BS, and outputs a detection result to the control unit 3.

The control unit 3 may determine whether or not the prescribed pressure is acting on the contact regions 122AS and 122BS at the prescribed position and the prescribed angle in each operation of the work using the articulated robot 10 on the basis of the pressure distribution, the position information, and the angle information received from the sensor ICs 4A and 4B. When a determination is made that a prescribed pressure is acting on the contact regions 122AS and 122BS at the prescribed position and the prescribed angle, the control unit 3 causes the articulated robot 10 to perform the next operation. On the other hand, when a determination is made that the prescribed pressure is not acting on the contact regions 122AS and 122BS at the prescribed position and the prescribed angle, the control unit 3 may cause the articulated robot 10 to perform the same operation again. When a determination is made that the prescribed pressure is not acting on the contact regions 122AS and 122BS at the prescribed position and the prescribed angle, the control unit 3 may stop the work using the articulated robot 10.

Specifically, for example, in step S17 (see FIG. 16) of the first embodiment, the control unit 3 collates the position information and angle information of the contact regions 122AS and 122BS received via the sensor ICs 4A and 4B with the position information and angle information of the contact regions 122AS and 122BS stored the storage apparatus 3A. When position information and angle information of both the contact regions 122AS and 122BS have been collated in step S17, the control unit 3 advances the processing to step S18. On the other hand, when the position information and angle information of one or both of the contact regions 122AS and 122BS cannot be collated in step S17, the control unit 3 returns the processing to step S12.

Even when a workpiece gripped by the robot hand 12 slips and a contact position between the contact regions 122AS and 122BS and the workpiece is shifted, the control unit 3 can estimate accurate position information on the basis of position information (three-dimensional coordinate information and angle information) of the position sensors 124A and 124B and an amount of position shift in the in-plane direction of the contact regions 122AS and 122BS. Therefore, it is possible to perform work in which it is important to hold without tilting (for example, precise fitting work). For example, in fitting work, the force sensors 20A and 20B are deformed by the shearing force, and change in an absolute position of the workpiece can be corrected. When the workpiece gripped by the robot hand 12 does not slip and the force sensors 20A and 20B are deformed and moved by the shearing force, the control unit 3 can calculate a movement vector from outputs of the force sensors 20A and 20B. The control unit 3 may learn for return of an amount of movement, and control the robot hand 12 on the basis of the learning.

### Modification Example 4

The same work may be repeatedly performed to cause the control unit 3 to perform machine learning. The storage apparatus 3A may store a learned model.

### Modification Example 5

The control unit 3 may calculate gripping force on the basis of the pressure distribution received from the sensor ICs 4A and 4B. The sensor IC 4A may calculate the gripping force on the basis of the pressure distribution acquired from the force sensor 20A, or the sensor IC 4B may calculate the gripping force on the basis of the pressure distribution acquired from the force sensor 20B.

### Modification Example 6

Although an example in which the control unit 3 determines whether or not the contact region 122BS has reached the prescribed position, to stop the work for bending the material 101 has been described in the first embodiment, the work for bending the material 101 may be stopped on the basis of information other than the prescribed position.

For example, the control unit 3 may stop the work for bending the material 101 on the basis of a distance between the contact region 122AS and the contact region 122BS. Hereinafter, details of this example will be described.

The storage apparatus 3A stores a prescribed distance for stopping the work for bending the material 101. The control unit 3 calculates the distance between the contact region 122AS and the contact region 122BS from the position information of the contact region 122AS received from the position sensor 124A and the position information of the contact region 122BS received from the position sensor 124B. The control unit 3 determines whether or not the calculated distance is equal to or smaller than the prescribed distance stored in the storage apparatus 3A. When a determination is made that the calculated distance is equal to or smaller than the prescribed distance stored in the storage apparatus 3A, the control unit 3 stops the work for bending the material 101 using the articulated robot 10. On the other hand, when a determination is made that the calculated distance is not equal to or smaller than the prescribed distance stored in the storage apparatus 3A, the control unit 3 continues the work for bending the material 101 using the articulated robot 10.

For example, the control unit 3 may stop the work for bending the material 101 on the basis of an angle between the normal direction of the contact region 122AS and the normal direction of the contact region 122BS. Hereinafter, details of this example will be described.

The finger portions 120A and 120B further include the angle sensors 126A and 126B in the contact regions 122AS and 122BS, respectively, as illustrated in FIG. 30. Further, the storage apparatus 3A stores a prescribed angle for stopping the work for bending the material 101. The control unit 3 calculates an angle formed by the normal direction of the contact region 122AS and the normal direction of the contact region 122BS from an angle in the normal direction of the contact region 122AS received from the angle sensor 126A and an angle in the normal direction of the contact region 122BS received from the angle sensor 126B. The control unit 3 determines whether or not the calculated angle formed by the normal directions is equal to or smaller than the prescribed angle stored in the storage apparatus 3A. When a determination is made that the formed angle is equal to or smaller than the prescribed angle stored in the storage apparatus 3A, the control unit 3 stops the work for bending the material 101 using the articulated robot 10. On the other hand, when a determination is made that the formed angle is not equal to or smaller than the prescribed angle stored in the storage apparatus 3A, the control unit 3 continues the work for bending the material 101 using the articulated robot 10.

### Other Modification Examples

The embodiments and the modification examples of the present disclosure have been described above in detail, but the present disclosure is not limited to the embodiments and modification examples, and various modifications are possible on the basis of the technical ideas of the present disclosure. For example, the configurations, methods, processes, shapes, materials, numerical values, and the like given in the embodiments and the modification examples are merely examples, and different configurations, methods, processes, shapes, materials, numerical values, and the like may be used as necessary. The configurations, methods, processes, shapes, materials, numerical values, and the like of the embodiments and the modification examples can be combined with each other without departing from the gist of the present disclosure. In numerical ranges described stepwise in the embodiments and the modification examples, an upper limit value or a lower limit value of the numerical range at a certain stage may be replaced with an upper limit value or a lower limit value of a numerical range at another stage. The materials illustrated in the above embodiments and modification examples can be used alone as one type or as a combination of two or more types unless otherwise specified.

Further, the present disclosure can also adopt the following configuration.

(1)

A robot including:
an actuator unit; and
an end effector provided at a tip of the actuator unit,
wherein the end effector includes:
a first sensor configured to be able to detect pressure distribution in a contact region that comes into contact with a workpiece; and
a second sensor configured to be able to detect position information of the contact region.

(2)

The robot according to (1),
wherein the first sensor includes a substrate, and
the second sensor is provided on the substrate.

(3)

The robot according to (2), wherein the substrate is a flexible substrate.

(4)

The robot according to any one of (1) to (3), wherein the first sensor is configured to be able to detect shearing force of the contact region.

(5)

The robot according to any one of (1) to (4), further including a third sensor configured to be able to detect angle information of the contact region.

(6)

The robot according to any one of (1) to (5), further including a camera configured to photograph the workpiece.

(7)

The robot according to any one of (1) to (6), wherein the first sensor includes:
a detection layer including a first surface and a second surface opposite to the first surface and including a capacitive sensing portion;
a first conductive layer provided to face the first surface of the detection layer;
a second conductive layer provided to face the second surface of the detection layer;
a first deformation layer provided between the first conductive layer and the detection layer and elastically deformed according to pressure acting in a thickness direction of the first sensor; and
a second deformation layer provided between the second conductive layer and the detection layer and elastically deformed according to the pressure acting in the thickness direction of the first sensor;

(8)

The robot according to any one of (1) to (6), wherein the first sensor includes:
a first detection layer including a first surface and a second surface opposite to the first surface and including a capacitive first sensing portion;
a second detection layer including a first surface facing the second surface of the first detection layer and including a capacitive type of second sensing portion;
a first conductive layer provided to face the first surface of the first detection layer; a second conductive layer provided between the first detection layer and the second detection layer;
an isolation layer provided between the first detection layer and the second conductive layer to isolate the first detection layer from the second conductive layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

(9)

The robot according to any one of (1) to (6), wherein the first sensor includes:
a first detection layer including a first surface and a second surface opposite to the first surface and including a capacitive first sensing portion;
a second detection layer including a first surface facing the second surface of the first detection layer and a second surface opposite to the first surface, and including a capacitive type of second sensing portion;
an isolation layer provided between the first detection layer and the second detection layer to isolate the first detection layer from the second detection layer;
a first conductive layer provided to face the first surface of the first detection layer; a second conductive layer provided to face the second surface of the second detection layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

(10)

The robot according to (9), wherein the isolation layer includes:
a third conductive layer;
a first isolation layer provided between the first detection layer and the third conductive layer to isolate the first detection layer from the third conductive layer; and a second isolation layer provided between the third conductive layer and the second detection layer to isolate the third conductive layer from the second detection layer.

(11)

The robot according to (9),
wherein the first sensor further includes:
a fourth conductive layer provided between the first detection layer and the isolation layer;
a third deformation layer provided between the first detection layer and the fourth conductive layer;
a fifth conductive layer provided between the isolation layer and the second detection layer; and a fourth deformation layer provided between the fifth conductive layer and the second detection layer.

(12)

The robot according to any one of (8) to (11), wherein a thickness of the isolation layer is twice or more the thickness of the first deformation layer, and
the thickness of the isolation layer is twice or more the thickness of the second deformation layer.

(13)

The robot according to any one of (8) to (12), wherein a basis weight of the isolation layer is ten times or more the basis weight of the first deformation layer, and
the basis weight of the isolation layer is ten times or more the basis weight of the second deformation layer.

(14)

The robot according to any one of (8) to (13), wherein the isolation layer contains gel.

(15)

An end effector including:
a first sensor configured to be able to detect pressure distribution in a contact region coming into contact with a workpiece; and
a second sensor configured to be able to detect position information of the contact region.

(16)

A robot system including:
a robot; and
a control apparatus configured to control the robot,
wherein the robot includes
an actuator unit; and
an end effector provided at a tip of the actuator unit, and
the end effector includes:
a first sensor configured to be able to detect a pressure distribution in a contact region coming into contact with a workpiece; and
a second sensor configured to be able to detect position information of the contact region.

(17)

The robot system according to (16), wherein the control apparatus determines whether or not prescribed pressure is acting on the contact region at a prescribed position, on the basis of the pressure distribution detected by the first sensor and the position information detected by the second sensor.

(18)

The robot system according to (16) or (17), wherein the first sensor includes:
a first detection layer including a first surface and a second surface opposite to the first surface and including a capacitive first sensing portion;
a second detection layer including a first surface facing the second surface of the first detection layer and including a capacitive type of second sensing portion;
a first conductive layer provided to face the first surface of the first detection layer; a second conductive layer provided between the first detection layer and the second detection layer;
an isolation layer provided between the first detection layer and the second conductive layer to isolate the first detection layer from the second conductive layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

(19)

The robot system according to (18), wherein the control apparatus calculates shearing force from a capacitance distribution detected by the first detection layer and a capacitance distribution detected by the second detection layer.

(20)

The robot system according to (18) or (19), wherein the control apparatus calculates an amount of position shift of the workpiece gripped by the end effector, on the basis of a capacitance distribution detected by the first detection layer and a capacitance distribution detected by the second detection layer.

### REFERENCE SIGNS LIST

1 Robot control apparatus
2 Operation unit
3 Control unit
3A Storage apparatus
4A, 4B Sensor IC
5 Notification unit
10 Articulated robot
11 Robot arm
12 Robot hand
13 Camera
14 Jig apparatus
14A Jig
14B Drive unit
20A, 20B, 40, 50, 60, 70, 80 Force sensor
20S Sensing surface
21A, 21B, 21C, 51B, 61A, 61B, 71 Detection layer
21A1 Connection portion
21A2 Connection terminal
21AS1, 21BS1, 3151, 51BS1, 61AS1, 61BS1, 71AS1, 71BS1 First surface
21AS2, 21BS2, 31S2, 51BS2, 61AS2, 61BS2, 71AS2, 71BS2 Second surface
22, 25, 25A, 25B, 52, 62, 72 Isolation layer
23A, 23B, 53B, 63A, 63B, 73, 81 Deformation layer
24A, 24B, 24C, 54B, 54C, 64A, 64B, 74A, 74B Conductive layer
31 Base material
32, 33, 38 Plurality of routing wirings
34A, 34B Coverlay film
35A, 35B Adhesive layer
36 Sense electrode
36A Connection line
37 Pulse electrode
37A Lead wiring
37B Through hole
41 Object
55 Adhesive layer
60A First force sensor
60B Second force sensor
82 Exterior material
111 Base portion
112A, 112B, 112C, 112D, 123A, 123B Joint portion
113A, 113B, 113C, 120C, 121A, 121B, 122A, 122B Link
114A, 114B, 114C, 114D, 125A, 125B Drive unit
120A and 120B Finger portion
122AS and 122BS Contact region
124A, 124B Position sensor
126A, 126B Angle sensor
DB1, DB2 Output signal distribution
P1, P2 Disposition pitch
SE21, SE22, SE23, SE52, SE61, SE62, SE71 Sensing portion

1. A robot comprising:
an actuator unit; and
an end effector provided at a tip of the actuator unit,
wherein the end effector includes:
a first sensor configured to be able to detect pressure distribution in a contact region that comes into contact with a workpiece; and
a second sensor configured to be able to detect position information of the contact region.

2. The robot according to claim 1,
wherein the first sensor includes a substrate, and
the second sensor is provided on the substrate.

3. The robot according to claim 2, wherein the substrate is a flexible substrate.

4. The robot according to claim 1, wherein the first sensor is configured to be able to detect shearing force of the contact region.

5. The robot according to claim 1, further comprising a third sensor configured to be able to detect angle information of the contact region.

6. The robot according to claim 1, further comprising a camera configured to photograph the workpiece.

7. The robot according to claim 1,
wherein the first sensor includes:
a detection layer including a first surface and a second surface opposite to the first surface and including a capacitive sensing portion;
a first conductive layer provided to face the first surface of the detection layer;
a second conductive layer provided to face the second surface of the detection layer;
a first deformation layer provided between the first conductive layer and the detection layer and elastically deformed according to pressure acting in a thickness direction of the first sensor; and
a second deformation layer provided between the second conductive layer and the detection layer and elastically deformed according to the pressure acting in the thickness direction of the first sensor.

8. The robot according to claim 1, wherein the first sensor includes:
a first detection layer including a first surface and a second surface opposite to the first surface and including a capacitive first sensing portion;
a second detection layer including a first surface facing the second surface of the first detection layer and including a capacitive type of second sensing portion;
a first conductive layer provided to face the first surface of the first detection layer;
a second conductive layer provided between the first detection layer and the second detection layer;
an isolation layer provided between the first detection layer and the second conductive layer to isolate the first detection layer from the second conductive layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

9. The robot according to claim 1, wherein the first sensor includes:
a first detection layer including a first surface and a second surface opposite to the first surface and including a capacitive first sensing portion;
a second detection layer including a first surface facing the second surface of the first detection layer and a second surface opposite to the first surface, and including a capacitive type of second sensing portion;
an isolation layer provided between the first detection layer and the second detection layer to isolate the first detection layer from the second detection layer;
a first conductive layer provided to face the first surface of the first detection layer;
a second conductive layer provided to face the second surface of the second detection layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

10. The robot according to claim 9, wherein the isolation layer includes:
a third conductive layer;
a first isolation layer provided between the first detection layer and the third conductive layer to isolate the first detection layer from the third conductive layer; and
a second isolation layer provided between the third conductive layer and the second detection layer to isolate the third conductive layer from the second detection layer.

11. The robot according to claim 9,
wherein the first sensor further includes:
a fourth conductive layer provided between the first detection layer and the isolation layer;
a third deformation layer provided between the first detection layer and the fourth conductive layer;
a fifth conductive layer provided between the isolation layer and the second detection layer; and
a fourth deformation layer provided between the fifth conductive layer and the second detection layer.

12. The robot according to claim 9, wherein a thickness of the isolation layer is twice or more the thickness of the first deformation layer, and
the thickness of the isolation layer is twice or more the thickness of the second deformation layer.

13. The robot according to claim 9,
wherein a basis weight of the isolation layer is ten times or more the basis weight of the first deformation layer, and
the basis weight of the isolation layer is ten times or more the basis weight of the second deformation layer.

14. The robot according to claim 9, wherein the isolation layer contains gel.

15. An end effector comprising:
a first sensor configured to be able to detect pressure distribution in a contact region coming into contact with a workpiece; and
a second sensor configured to be able to detect position information of the contact region.

16. A robot system comprising:
a robot; and
a control apparatus configured to control the robot,
wherein the robot includes:
an actuator unit; and
an end effector provided at a tip of the actuator unit, and
the end effector includes:
a first sensor configured to be able to detect a pressure distribution in a contact region coming into contact with a workpiece; and
a second sensor configured to be able to detect position information of the contact region.

17. The robot system according to claim 16, wherein the control apparatus determines whether or not prescribed pressure is acting on the contact region at a prescribed position, on the basis of the pressure distribution detected by the first sensor and the position information detected by the second sensor.

18. The robot system according to claim 16, wherein the first sensor includes:
a first detection layer including a first surface and a second surface opposite to the first surface and including a capacitive first sensing portion;
a second detection layer including a first surface facing the second surface of the first detection layer and including a capacitive type of second sensing portion;
a first conductive layer provided to face the first surface of the first detection layer;
a second conductive layer provided between the first detection layer and the second detection layer;
an isolation layer provided between the first detection layer and the second conductive layer to isolate the first detection layer from the second conductive layer;
a first deformation layer provided between the first conductive layer and the first detection layer and elastically deformed according to pressure acting in a thickness direction of the first sensor; and
a second deformation layer provided between the second conductive layer and the second detection layer and elastically deformed according to the pressure acting in the thickness direction of the first sensor,
a 25% CLD value of the isolation layer is ten times or more the 25% CLD value of the first deformation layer, and
the 25% CLD value of the isolation layer is ten times or more the 25% CLD value of the second deformation layer.

19. The robot system according to claim 18, wherein the control apparatus calculates shearing force from a capacitance distribution detected by the first detection layer and a capacitance distribution detected by the second detection layer.

20. The robot system according to claim 18, wherein the control apparatus calculates an amount of position shift of the workpiece gripped by the end effector, on the basis of a capacitance distribution detected by the first detection layer and a capacitance distribution detected by the second detection layer.
